(19) United States
(12) Patent Application Publication
(10) Pub. No.: US 2019/0163286 A1
(43) Pub. Date: May 30, 2019

(54) ELECTRONIC DEVICE AND METHOD OF OPERATING SAME

(71) Applicant: SAMSUNG ELECTRONICS CO., LTD., Suwon-si (KR)

(72) Inventors: Choong-Hee Ahn, Hwaseong-si (KR); Young-Sub Lee, Suwon-si (KR); Won Suk Choi, Seoul (KR)

(21) Appl. No.: 16/263,142

(22) Filed: Jan. 31, 2019

Related U.S. Application Data
(63) Continuation of application No. 15/403,354, filed on Jan. 11, 2017.

(30) Foreign Application Priority Data
Jan. 12, 2016 (KR) 10-2016-0003738

(51) Int. Cl. G06F 3/0346; G06F 3/01; G06F 1/16; G06F 3/03; G06F 3/0484; H04W 4/50; G06F 3/0485; G06F 3/038

(52) U.S. Cl. CPC G06F 3/0346; G06F 3/011; G06F 1/163; G06F 3/015; G06F 3/017; H04W 4/80; G06F 1/1626; G06F 3/04845; H04W 4/50; G06F 3/0485; G06F 3/038; G06F 3/0304

(57) ABSTRACT

Disclosed are an electronic device and a method of operating the same. The electronic device may include: at least one sensor including one or more of a proximity sensor and a biometric sensor; a motion sensor; and a processor, wherein the processor may be configured to identify proximity of a user corresponding to the electronic device through the at least one sensor, to acquire a motion value corresponding to a motion of the electronic device based on the identification, and to execute at least one function based on the motion value.

### CROSS-REFERENCE TO RELATED APPLICATION

This application is based on and claims priority under 35 U.S.C. § 119 to Korean Application Serial No. 10-2016-0003738, which was filed in the Korean Intellectual Property Office on Jan. 12, 2016, the content of which is incorporated by reference herein in its entirety.

### TECHNICAL FIELD

The present disclosure relates generally to an electronic device including a plurality of sensors and a method of operating the same.

### BACKGROUND

Electronic devices may perform complex functions through a combination of various functions. For example, the electronic device may perform a mobile communication function, a data communication function, a data output function, or an image photographing function. The electronic device may include a display unit and an input unit. Recently, the display unit and the input unit are combined and generally implemented in the form of a touch screen. The electronic device may output a screen corresponding to a signal input through the touch screen to the touch screen.

As the screen of the electronic device becomes larger, the user has difficulty using the electronic device with one hand.

### SUMMARY

Various embodiments of the present disclosure address the conventional problems provide an electronic device and a method of operating the same that, when a user motion generated in the electronic device is detected, allow the user to easily control the electronic device based on the detected motion.

An electronic device according to an example embodiment of the present disclosure includes: at least one sensor from among a proximity sensor and a biometric sensor; a motion sensor; and a processor, wherein the processor is configured to determine the proximity of a user of the electronic device through the at least one sensor, to acquire a motion value corresponding to a motion of the electronic device based on detection by the motion sensor, and to execute at least one function based on the motion value.

A method of operating an electronic device according to an example embodiment of the present disclosure includes: displaying screen data; identifying proximity of a user through at least one sensor from among a proximity sensor and a biometric sensor; detecting a motion of the electronic device through a motion sensor when the proximity of the user is identified; and executing at least one function corresponding to the motion.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example network environment including an electronic device according to an example embodiment of the present disclosure;

FIG. 2 is a block diagram illustrating an example electronic device according to an example embodiment of the present disclosure;

FIG. 3 is a block diagram illustrating an example program module according to an example embodiment of the present disclosure;

FIG. 4 is a block diagram illustrating an example electronic device according to an example embodiment of the present disclosure;

FIG. 5 is a flowchart illustrating an example method of operating an electronic device according to an example embodiment of the present disclosure;

FIG. 6 is a flowchart illustrating an example method of recognizing a motion based on the gravity acceleration detected by an electronic device according to an example embodiment of the present disclosure;

FIG. 7 is a flowchart illustrating an example method of recognizing a motion based on a rotation angle detected by an electronic device according to an example embodiment of the present disclosure;

FIG. 8 is a flowchart illustrating an example method of performing a control based on a motion recognized by an electronic device according to an example embodiment of the present disclosure;

FIG. 9 is a flowchart illustrating an example method of operating an application when an electronic device executes the application according to an example embodiment of the present disclosure;

FIG. 10 is a flowchart illustrating an example method of operating motion recognition in an executed application according to an example embodiment of the present disclosure;

FIGS. 11A, 11B and 11C are diagrams illustrating examples of a screen for controlling a keypad based on a rotation angle of an electronic device according to an example embodiment of the present disclosure;

FIGS. 12A, 12B and 12C are diagrams illustrating examples of a screen for controlling tab menus based on a rotation angle of an electronic device according to an example embodiment of the present disclosure;

FIGS. 13A, 13B and 13C are diagrams illustrating examples of a screen for controlling map data based on the gravity acceleration of an electronic device according to an example embodiment of the present disclosure;

FIGS. 14A and 14B are diagrams illustrating examples of a screen for controlling a webpage upwardly and downwardly based on the gravity acceleration of an electronic device according to an example embodiment of the present disclosure;

FIGS. 15A and 15B are diagrams illustrating examples of a screen for controlling a webpage in left and right directions based on the gravity acceleration of an electronic device according to an example embodiment of the present disclosure;

FIGS. 16A and 16B are diagrams illustrating examples of a screen for controlling brightness of the screen based on user proximity information detected by an electronic device according to an example embodiment of the present disclosure;

FIGS. 17A, 17B, 17C and 17D are diagrams illustrating examples of a screen for performing a function based on a rotation angle of an electronic device when a call is received according to an example embodiment of the present disclosure;

FIG. 18 is a diagram illustrating an example of a screen for displaying floating menus in an electronic device according to an example embodiment of the present disclosure;

FIGS. 19A, 19B, and 19C and FIGS. 20A, 20B and 20C are diagrams illustrating examples of a screen for controlling an executed application based on a rotation angle of an electronic device according to an example embodiment of the present disclosure;

FIGS. 21A, 21B and 21C and FIGS. 22A, 22B and 22C are diagrams illustrating examples of a screen for controlling a background screen based on a rotation angle of an electronic device according to an example embodiment of the present disclosure;

FIGS. 23A and 23B are diagrams illustrating examples of a screen for controlling call origination based on a rotation angle of an electronic device according to an example embodiment of the present disclosure;

FIG. 24 is a diagram illustrating a system including an electronic device and an accessory device according to another example embodiment of the present disclosure;

FIG. 25 is a flowchart illustrating an example operation in which an electronic device is paired with an accessory device according to another example embodiment of the present disclosure;

FIG. 26 is a flowchart illustrating an example operation in which an electronic device performing pairing based on heartbeat information of an accessory device according to another example embodiment of the present disclosure;

FIG. 27 is a flowchart illustrating an example operation in which an accessory device transmits heartbeat information to an electronic device to perform pairing according to another example embodiment of the present disclosure;

FIG. 28 is a diagram illustrating an example system including an electronic device and an external electronic device according to another example embodiment of the present disclosure; and

FIG. 29 is a diagram illustrating locations of sensors included in an electronic device and an accessory device according to another example embodiment of the present disclosure.

### DETAILED DESCRIPTION

Various example embodiments of the present disclosure are described in greater detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure. The terms used herein are defined in consideration of functions of the present disclosure and may vary depending on a user's or an operator's intention and usage. Therefore, the terms used herein should be understood based on the descriptions made herein. It is to be understood that the singular forms “a,” “an,” and “the” include plural referents unless the context clearly dictates otherwise. In the present disclosure, an expression such as “A or B,” “at least one of A and B,” or “one or more of A and B” may include all possible combinations of the listed items. Expressions such as “first,” “second,” “primarily,” or “secondary,” as used herein, may represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)” used in the present disclosure may be used interchangeably with, for example, “suitable for,” “having the capacity to,” “designed to,” “adapted to,” “made to,” or “capable of” based on a situation. A term “configured to (or set)” does not only mean “specifically designed to” by hardware. In some situations, the expression “apparatus configured to” may refer, for example, to a situation in which the apparatus “can” operate together with another apparatus or component. For example, a phrase “a processor configured (or set) to perform A, B, and C” may refer, for example, to a dedicated processor, a generic-purpose processor (such as a Central Processing Unit (CPU) or an application processor) that can perform a corresponding operation by executing at least one software program stored at an exclusive processor (such as an embedded processor) for performing a corresponding operation or at a memory device.

An electronic device according to embodiments of the present disclosure, may be embodied as, for example, at least one of a smart phone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), an MPEG 3 (MP3) player, a medical equipment, a camera, and a wearable device, or the like, but is not limited thereto. The wearable device can include at least one of an accessory type (e.g., a watch, a ring, a bracelet, an ankle bracelet, a necklace, glasses, a contact lens, or a Head-Mounted-Device (HMD)), a fabric or clothing embedded type (e.g., electronic garments), a body attachable type (e.g., a skin pad or a tattoo), and an implantable circuit, or the like, but is not limited thereto. The electronic device may be embodied as at least one of, for example, a television, a Digital Versatile Disc (DVD) player, an audio device, a refrigerator, an air-conditioner, a cleaner, an oven, a microwave oven, a washing machine, an air cleaner, a set-top box, a home automation control panel, a security control panel, a media box (e.g., Samsung HomeSync™, Apple TV′, or Google TV™), a game console (e.g., Xbox™, PlayStation™), an electronic dictionary, an electronic key, a camcorder, and an electronic frame, or the like, but is not limited thereto.

In another embodiment, the electronic device may be embodied as at least one of various medical devices (such as, various portable medical measuring devices (a blood sugar measuring device, a heartbeat measuring device, a blood pressure measuring device, or a body temperature measuring device), a Magnetic Resonance Angiography (MRA) device, a Magnetic Resonance Imaging (MRI) device, a Computed Tomography (CT) device, a scanning machine, and an ultrasonic wave device), a navigation device, a Global Navigation Satellite System (GNSS), an Event Data Recorder (EDR), a Flight Data Recorder (FDR), a vehicle infotainment device, electronic equipment for ship (such as, a navigation device for ship and gyro compass), avionics, a security device, a head unit for a vehicle, an industrial or home robot, a drone, an Automated Teller Machine (ATM) of a financial institution, a Point Of Sales (POS) device of a store, and an Internet of Things (IoT) device (e.g., a light bulb, various sensors, a sprinkler device, a fire alarm, a thermostat, a street light, a toaster, sports equipment, a hot water tank, a heater, and a boiler), or the like, but is not limited thereto. According to an embodiment, the electronic device may be embodied as at least one of a portion of furniture, building/construction or vehicle, an electronic board, an electronic signature receiving device, a projector, and various measuring devices (e.g., water supply, electricity, gas, or electric wave measuring device), or the like, but is not limited thereto. An electronic device, according to an embodiment, can be a flexible electronic device or a combination of two or more of the foregoing various devices. An electronic device, according to an embodiment of the present disclosure, is not limited to the foregoing devices may be embodied as a newly developed electronic device. The term “user”, as used herein, can refer to a person using an electronic device or a device using an electronic device (e.g., an artificial intelligence electronic device).

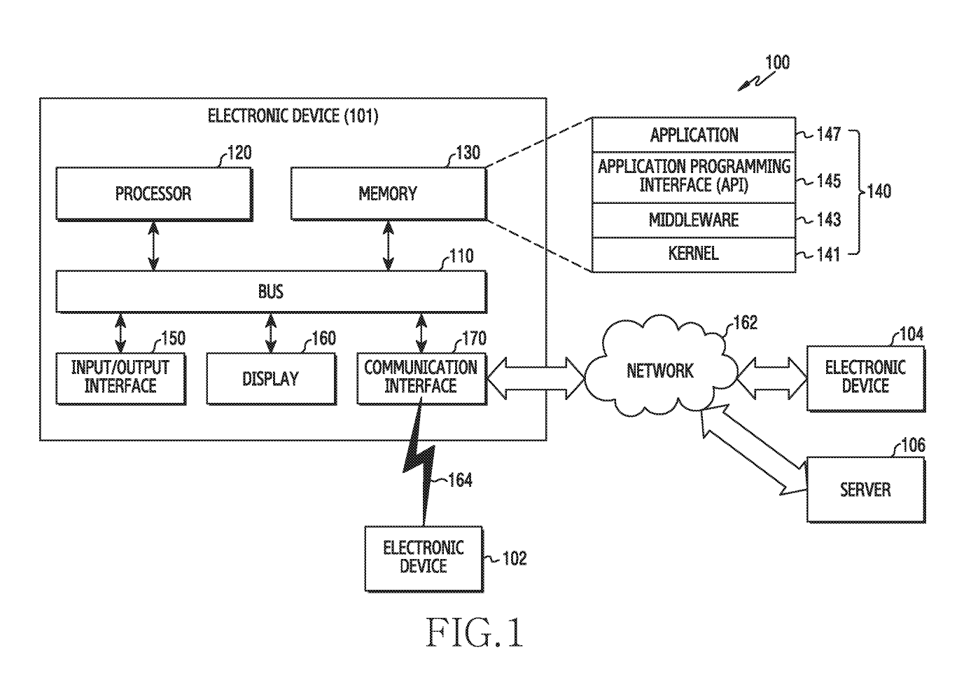

Referring initially to FIG. 1, an electronic device 101 resides in a network environment 100. The electronic device 101 can include a bus 110, a processor (e.g., including processing circuitry) 120, a memory 130, an input/output interface (e.g., including input/output circuitry) 150, a display 160, and a communication interface (e.g., including communication circuitry) 170. The electronic device 101 may be provided without at least one of the components, or may include at least one additional component. The bus 110 can include a circuit for connecting the components 120 through 170 and delivering communication signals (e.g., control messages or data) therebetween.

The processor 120 may include various processing circuitry, such as, for example, and without limitation, one or more of a dedicated processor, a CPU, an application processor, and a Communication Processor (CP). The processor 120, for example, can perform an operation or data processing with respect to control and/or communication of at least another component of the electronic device 101.

The memory 130 can include a volatile and/or nonvolatile memory. The memory 130, for example, can store commands or data relating to at least another component of the electronic device 101. According to an embodiment, the memory 130 can store software and/or a program 140.

The program 140 can include, for example, a kernel 141, middleware 143, an Application Programming Interface (API) 145, and/or an application program (or “application”) 147. At least part of the kernel 141, the middleware 143, or the API 145 can be referred to as an Operating System (OS). The kernel 141 can control or manage system resources (e.g., the bus 110, the processor 120, or the memory 130) used for performing operations or functions implemented by the other programs (e.g., the middleware 143, the API 145, or the application program 147). Additionally, the kernel 141 can provide an interface for controlling or managing system resources by accessing an individual component of the electronic device 101 from the middleware 143, the API 145, or the application program 147.

The middleware 143, for example, can serve an intermediary role for exchanging data between the API 145 or the application program 147 and the kernel 141 through communication. Additionally, the middleware 143 can process one or more job requests received from the application program 147, based on their priority. For example, the middleware 143 can assign a priority for using a system resource (e.g., the bus 110, the processor 120, or the memory 130) of the electronic device 101 to at least one of the application programs 147, and process the one or more job requests. The API 145, as an interface through which the application 147 controls a function provided from the kernel 141 or the middleware 143, can include, for example, at least one interface or function (e.g., an instruction) for file control, window control, image processing, or character control. The input/output interface 150, for example, can deliver commands or data inputted from a user or another external device to other component(s) of the electronic device 101, or output commands or data inputted from the other component(s) of the electronic device 101 to the user or another external device.

The display 160, for example, can include a Liquid Crystal Display (LCD), a Light Emitting Diode (LED) display, an Organic Light Emitting Diode (OLED) display, a MicroElectroMechanical Systems (MEMS) display, or an electronic paper display, or the like, but is not limited thereto. The display 160, for example, can display various contents (e.g., texts, images, videos, icons, and/or symbols) to the user. The display 160 can include a touch screen, for example, and receive touch, gesture, proximity, or hovering inputs by using an electronic pen or a user's body part.

The communication interface 170 may include various communication circuitry and can, for example, set a communication between the electronic device 101 and an external device (e.g., a first external electronic device 102, a second external electronic device 104, or a server 106). For example, the communication interface 170 can communicate with the external device (e.g., the second external electronic device 104 or the server 106) over a network 162 through wireless communication or wired communication.

The wireless communication, for example, can include cellular communication using at least one of Long Term Evolution (LTE), LTE-Advanced (LTE-A), Code Division Multiple Access (CDMA), Wideband CDMA (WCDMA), Universal Mobile Telecommunications System (UNITS), Wireless Broadband (WiBro), or Global System for Mobile Communications (GSM). The wireless communication can include short-range communication 164, for example, at least one of Wireless Fidelity (WiFi), Bluetooth, Bluetooth Low Energy (BLE), Zigbee, Near Field Communication (NFC), magnetic secure transmission, Radio Frequency (RF), and Body Area Network (BAN). The wireless communication can include GNSS. The GNSS can include, for example, Global Positioning System (GPS), Global Navigation Satellite System (GLONASS), Beidou navigation satellite system (Beidou), or Galileo (the European global satellite-based navigation system). Hereafter, the GPS can be interchangeably used with the GNSS. The wired communication, for example, can include at least one of Universal Serial Bus (USB), High Definition Multimedia Interface (HDMI), Recommended Standard 232 (RS-232), power line communications, and Plain Old Telephone Service (POTS). The network 162 can include a telecommunications network, for example, at least one of computer network (e.g., LAN or WAN), Internet, and telephone network.

Each of the first and second external electronic devices 102 and 104 can be of the same as or of a different type from that of the electronic device 101. According to embodiments of the present disclosure, all or part of operations executed in the electronic device 101 can be executed by another electronic device or a plurality of electronic devices (e.g., the electronic device 102 or 104, or the server 106). To perform a function or service automatically or by request, instead of performing the function or the service by the electronic device 101, the electronic device 101 can request at least part of a function relating thereto from another device (e.g., the electronic device 102 or 104, or the server 106). The other electronic device (e.g., the electronic device 102 or 104, or the server 106) can perform the requested function or an additional function and send its result to the electronic device 101. The electronic device 101 can provide the requested function or service by processing the received result. In doing so, for example, cloud computing, distributed computing, or client-server computing techniques can be used.

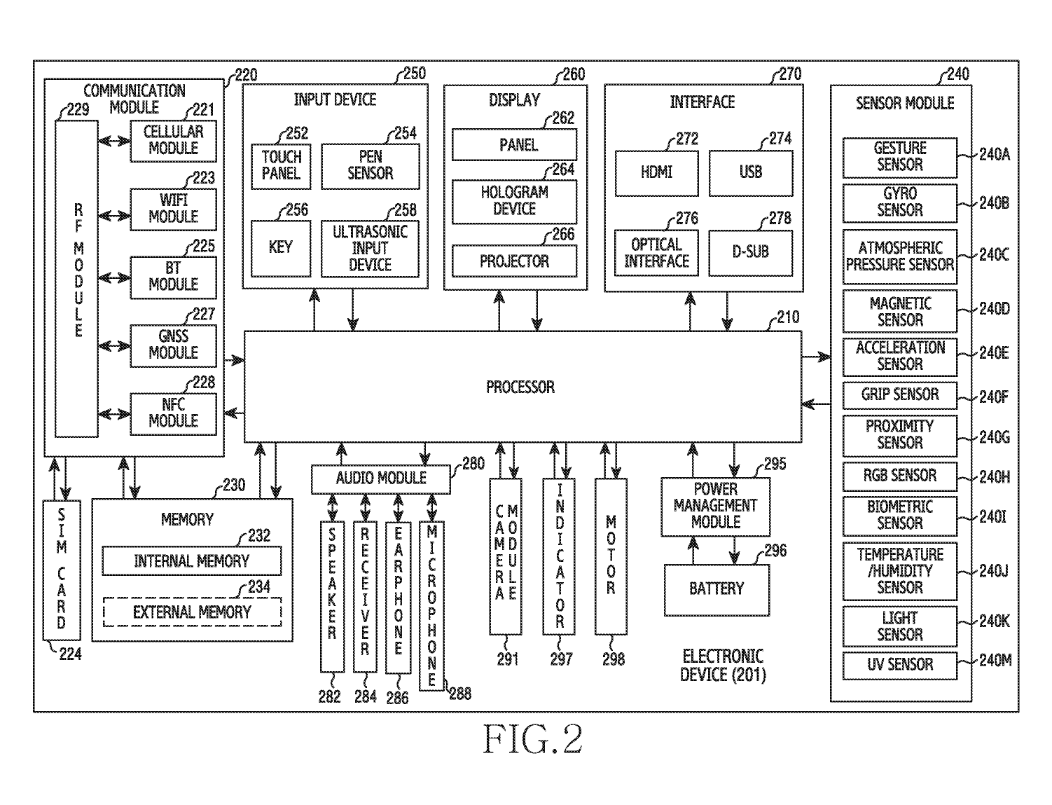

FIG. 2 is a block diagram illustrating an example electronic device 201 according to an example embodiment of the present disclosure.

The electronic device 201, for example, can include all or part of the above-described electronic device 101 of FIG. 1. The electronic device 201 includes one or more processors (e.g., an AP) (e.g., including processing circuitry) 210, a communication module (e.g., including communication circuitry) 220, a Subscriber Identification Module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210, for example, may include various processing circuitry and can be configured to control a plurality of hardware or software components connected to the processor 210, and also can perform various data processing and operations by executing an OS or an application program. The processor 210 can be implemented with a System on Chip (SoC), for example. The processor 210 can further include a Graphic Processing Unit (GPU) and/or an image signal processor. The processor 210 may include at least part (e.g., a cellular module 221) of the components shown in FIG. 2. The processor 210 can load commands or data received from at least one other component (e.g., a nonvolatile memory) into a volatile memory, process them, and store various data in the nonvolatile memory.

The communication module 220 can have the same or similar configuration to the communication interface 170 of FIG. 1. The communication module 220 may include various communication circuitry, such as, for example, and without limitation, the cellular module 221, a WiFi module 223, a Bluetooth (BT) module 225, a GNSS module 227, an NFC module 228, and an RF module 229. The cellular module 221, for example, can provide voice call, video call, Short Message Service (SMS), or Internet service through a communication network. The cellular module 221 can identify and authenticate the electronic device 201 in a communication network by using the SIM (e.g., a SIM card) 224. The cellular module 221 can perform at least part of a function that the processor 210 provides. The cellular module 221 can further include a CP. At least some (e.g., two or more) of the cellular module 221, the WiFi module 223, the BT module 225, the GNSS module 227, and the NFC module 228 can be included in one Integrated Circuit (IC) or an IC package. The RF module 229, for example, can transmit/receive a communication signal (e.g., an RF signal). The RF module 229, for example, can include a transceiver, a Power Amp Module (PAM), a frequency filter, a Low Noise Amplifier (LNA), or an antenna. According to another embodiment, at least one of the cellular module 221, the WiFi module 223, the BT module 225, the GNSS module 227, and the NFC module 228 can transmit/receive an RF signal through an additional RF module. The SIM 224, for example, can include a card including a SIM or an embedded SIM, and also can contain unique identification information (e.g., an Integrated Circuit Card Identifier (ICCID)) or subscriber information (e.g., an International Mobile Subscriber Identity (IMSI)).

The memory 230 (e.g., the memory 130) can include at least one of an internal memory 232 and/or an external memory 234. The internal memory 232 can include at least one of, for example, a volatile memory (e.g., Dynamic RAM (DRAM), Static RAM (SRAM), or Synchronous Dynamic RAM (SDRAM)), and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, flash memory, hard drive, and solid state drive (SSD)). The external memory 234 can include flash drive, for example, Compact Flash (CF), Secure Digital (SD), micro SD, mini SD, extreme digital (xD), Multi-Media Card (MMC), or memory stick. The external memory 234 can be functionally or physically connected to the electronic device 201 through various interfaces.

The sensor module 240 can, for example, measure physical quantities or detect an operating state of the electronic device 201, and thus convert the measured or detected information into electrical signals. The sensor module 240 can include at least one of a gesture sensor 240A, a gyro sensor 240B, an atmospheric pressure sensor 240C, a magnetic sensor 240D, an acceleration sensor 240E, a grip sensor 240F, a proximity sensor 240G a color sensor 240H (e.g., a Red, Green, Blue (RGB) sensor), a biometric sensor 240I, a temperature/humidity sensor 240J, an illumination (e.g., light) sensor 240K, and an Ultra Violet (UV) sensor 240M. Additionally or alternately, the sensor module 240 can include an E-nose sensor, an Electromyography (EMG) sensor, an Electroencephalogram (EEG) sensor, an Electrocardiogram (ECG) sensor, an InfraRed (IR) sensor, an iris sensor, and/or a fingerprint sensor. The sensor module 240 can further include a control circuit for controlling at least one sensor therein. The electronic device, as part of the processor 210 or individually, can further include a processor configured to control the sensor module 240 and thus control the sensor module 240 while the processor 210 is sleeping.

The input device 250 may include various input circuitry, such as, for example, and without limitation, at least one of a touch panel 252, a (digital) pen sensor 254, a key 256, and an ultrasonic input device 258. The touch panel 252 can use at least one of, for example, capacitive, resistive, infrared, and ultrasonic methods. Additionally, the touch panel 252 can further include a control circuit. The touch panel 252 can further include a tactile layer to provide a tactile response to a user. The (digital) pen sensor 254 can include, for example, part of a touch panel or a sheet for recognition. The key 256 can include, for example, a physical button, a touch key, an optical key, or a keypad. The ultrasonic input device 258 can detect ultrasonic waves from an input means through a microphone 288 and check data corresponding to the detected ultrasonic waves.

The display 260 (e.g., the display 160) can include at least one of a panel 262, a hologram device 264, a projector 266, and/or a control circuit for controlling them. The panel 262 can be implemented to be flexible, transparent, or wearable, for example. The panel 262 and the touch panel 252 can be configured with one or more modules. The panel 262 can include a pressure sensor (or a force sensor) for measuring a pressure of the user touch. The pressure sensor can be integrated with the touch panel 252, or include one or more sensors separately from the touch panel 252. The hologram device 264 can show three-dimensional images in the air by using the interference of light. The projector 266 can display an image by projecting light on a screen. The screen, for example, can be placed inside or outside the electronic device 201.

The interface 270 may include various interface circuitry, such as, for example, and without limitation, an HDMI 272, a USB 274, an optical interface 276, or a D-subminiature (D-sub) 278. The interface 270 can be included in, for example, the communication interface 170 of FIG. 1. Additionally or alternately, the interface 270 can include a Mobile High-Definition Link (MHL) interface, a SD card/MMC interface, or an Infrared Data Association (IrDA) standard interface.

The audio module 280, for example, can convert sounds into electrical signals and convert electrical signals into sounds. At least some components of the audio module 280 can be included in, for example, the input/output interface 150 of FIG. 1. The audio module 280 can process sound information inputted or outputted through a speaker 282, a receiver 284, an earphone 286, or the microphone 288. The camera module 291, as a device for capturing still images and videos, can include one or more image sensors (e.g., a front sensor or a rear sensor), a lens, an Image Signal Processor (ISP), or a flash (e.g., an LED or a xenon lamp). The power management module 295, for example, can manage the power of the electronic device 201. According to an embodiment of the present disclosure, the power management module 295 can include a Power Management IC (PMIC), a charger IC, or a battery or fuel gauge, for example. The PMIC can have a wired and/or wireless charging method. The wireless charging method can include, for example, a magnetic resonance method, a magnetic induction method, or an electromagnetic method, and can further include an additional circuit for wireless charging, for example, a coil loop, a resonant circuit, or a rectifier circuit. The battery gauge can measure the remaining capacity of the battery 296, or a voltage, current, or temperature of the battery 296 during charging. The battery 296 can include, for example, a rechargeable battery and/or a solar battery.

The indicator 297 can display a specific state of the electronic device 201 or part thereof (e.g., the processor 210), for example, a booting state, a message state, or a charging state. The motor 298 can convert electrical signals into mechanical vibration and generate a vibration or haptic effect. The electronic device 201 can include a mobile TV supporting device (e.g., a GPU) for processing media data according to standards such as Digital Multimedia Broadcasting (DMB), Digital Video Broadcasting (DVB), or MediaFLOW™. Each of the above-described components of the electronic device can be configured with at least one component and the name of a corresponding component can vary according to the kind of an electronic device. According to an embodiment of the present disclosure, an electronic device (e.g., the electronic device 201) can be configured to include at least one of the above-described components or an additional component, or to not include some of the above-described components. Additionally, some of components in an electronic device are configured as one entity, so that functions of previous corresponding components are performed identically.

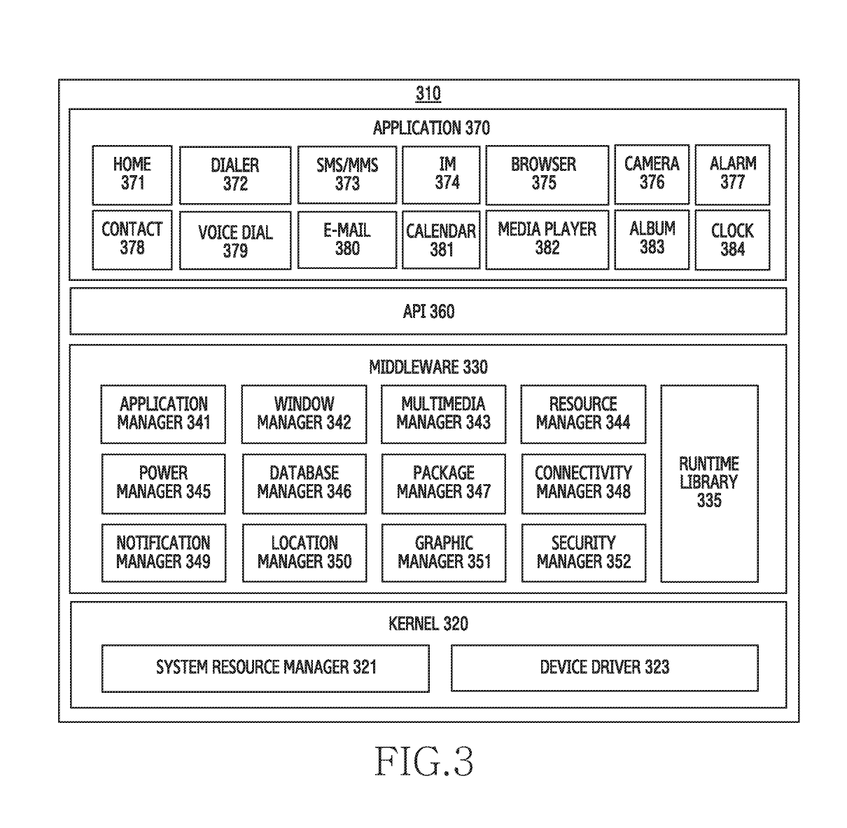

FIG. 3 is a block diagram illustrating an example program module according to an example embodiment of the present disclosure. A program module 310 (e.g., the program 140) can include an OS for controlling a resource relating to an electronic device (e.g., the electronic device 101) and/or various applications (e.g., the application program 147) running on the OS. The OS can include, for example, Android™, iOS™, Windows™, Symbian™, Tizen™, or Bada™.

Referring to FIG. 3, the program module 310 can include a kernel 320 (e.g., the kernel 141), a middleware 330 (e.g., the middleware 143), an API 360 (e.g., the API 145), and/or an application 370 (e.g., the application program 147). At least part of the program module 310 can be preloaded on an electronic device or can be downloaded from an external electronic device (e.g., the electronic device 102, 104, or the server 106).

The kernel 320 includes, for example, at least one of a system resource manager 321 and/or a device driver 323. The system resource manager 321 can control, allocate, or retrieve a system resource. According to an embodiment, the system resource manager 321 can include a process management unit, a memory management unit, or a file system management unit. The device driver 323 can include, for example, a display driver, a camera driver, a Bluetooth driver, a sharing memory driver, a USB driver, a keypad driver, a WiFi driver, an audio driver, or an Inter-Process Communication (IPC) driver.

The middleware 330, for example, can provide a function commonly required by the application 370, or can provide various functions to the application 370 through the API 360 in order to allow the application 370 to efficiently use a limited system resource inside the electronic device.

The middleware 330 includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include, for example, a library module used by a compiler to add a new function through a programming language while the application 370 is running. The runtime library 335 can manage input/output, manage memory, or arithmetic function processing. The application manager 341, for example, can manage the life cycle of the applications 370. The window manager 342 can manage a GUI resource used in a screen. The multimedia manager 343 can recognize a format for playing various media files and encode or decode a media file by using the codec in a corresponding format. The resource manager 344 can manage a source code of the application 3740 or a memory space. The power manager 345 can manage the capacity or power of the battery and provide power information for an operation of the electronic device. The power manager 345 can operate together with a Basic Input/Output System (BIOS). The database manager 346 can create, search, or modify a database used in the application 370. The package manager 347 can manage installation or updating of an application distributed in a package file format.

The connectivity manger 348 can manage, for example, a wireless connection. The notification manager 349 can provide an event, such as incoming messages, appointments, and proximity alerts, to the user. The location manager 350 can manage location information of an electronic device. The graphic manager 351 can manage a graphic effect to be provided to the user or a user interface relating thereto. The security manager 352 can provide, for example, system security or user authentication. The middleware 330 can include a telephony manager for managing a voice or video call function of the electronic device, or a middleware module for combining various functions of the above-described components. The middleware 330 can provide a module specialized for each type of OS. The middleware 330 can dynamically delete part of the existing components or add new components. The API 360, as a set of API programming functions, can be provided as another configuration according to the OS. For example, Android or iSO can provide one API set for each platform, and Tizen can provide two or more API sets for each platform.

The application 370 can include at least one of a home 371, a dialer 372, an SMS/Multimedia Messaging System (MIMS) 373, an Instant Message (IM) 374, a browser 375, a camera 376, an alarm 377, a contact 378, a voice dial 379, an e-mail 380, a calendar 381, a media player 382, an album 383, a clock 384, health care (e.g., measure an exercise amount or blood sugar level), or environmental information (e.g., air pressure, humidity, or temperature information) provision application. The application 370 can include an information exchange application for supporting information exchange between the electronic device and an external electronic device. The information exchange application can include, for example, a notification relay application for relaying specific information to the external device or a device management application for managing the external electronic device. For example, the notification relay application can relay notification information from another application of the electronic device to an external electronic device, or receive and forward notification information from an external electronic device to the user. The device management application, for example, can install, delete, or update a function (e.g., turn-on/turn off of the external electronic device itself (or some components) or display brightness (or resolution) adjustment) of an external electronic device communicating with the electronic device, or an application operating in the external electronic device. The application 370 can include a specified application (e.g., a health care application of a mobile medical device) according to a property of the external electronic device. The application 370 can include an application received from an external electronic device. At least part of the program module 310 can be implemented (e.g., executed) with software, firmware, hardware (e.g., the processor 210), or a combination of at least two of them, and include a module, a program, a routine, a set of instructions, or a process for executing one or more functions.

A term “module” used in the present disclosure includes a unit including hardware, software, and/or firmware, and may be interchangeably used with a term such as a unit, a logic, a logical block, a component, a circuit, and the like. The “module” may be an integrally constructed component or a minimum unit or one part thereof for performing one or more functions. The “module” may be mechanically or electrically implemented, and may include, for example, a dedicated processor, a CPU, an Application-Specific Integrated Circuit (ASIC) chip, a Field-Programmable Gate Arrays (FPGAs), or a programmable-logic device, which is known or to be developed to perform certain operations.

At least one part of an apparatus (e.g., modules or functions thereof) or method (e.g., operations) according to various example embodiments may be implemented with an instruction stored in a computer-readable storage media (e.g., the memory 130). If the instruction is executed by one or more processors (e.g., the processor 120), the one or more processors may perform a function corresponding to the instruction. The computer-readable storage media may include a hard disk, a floppy disk, magnetic media (e.g., a magnetic tape), optical media (e.g., a Compact Disc-ROM (CD-ROM), a Digital Versatile Disc (DVD), magnetic-optic media (e.g., a floptical disk)), an internal memory, or the like. The instruction may include a code created by a compiler or a code executable by an interpreter.

The module or programming module according to various example embodiments may further include at least one or more elements among the aforementioned elements, or may omit some of them, or may further include additional other elements. Operations performed by a module, programming module, or other elements may be executed in a sequential, parallel, repetitive, or heuristic manner. In addition, some of the operations may be executed in a different order or may be omitted, or other operations may be added.

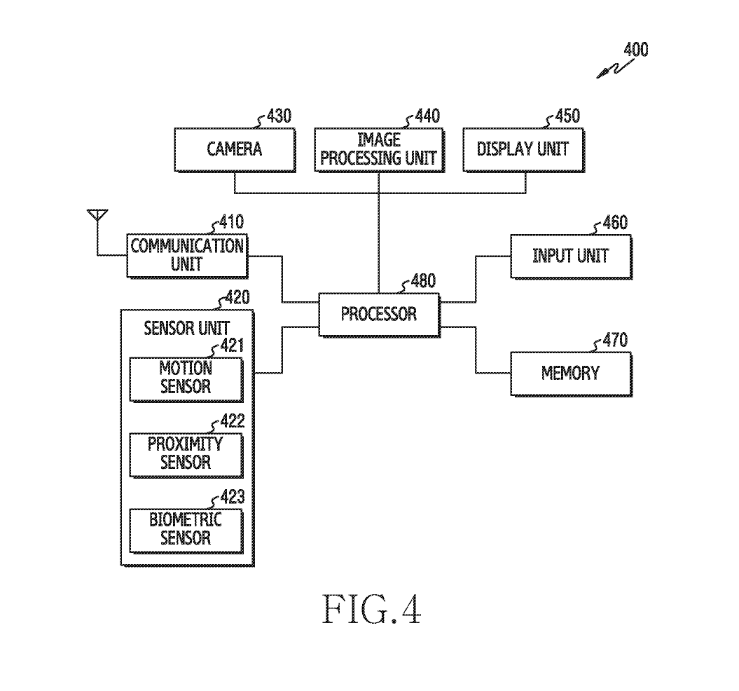

FIG. 4 is a block diagram illustrating an example electronic device according to an example embodiment of the present disclosure.

Referring to FIG. 4, an electronic device 400 according to an example embodiment of the present disclosure may include a communication unit (e.g., including communication circuitry) 410, a sensor unit 420, a camera 430, an image processing unit (e.g., including image processing circuitry) 440, a display unit 450, an input unit (e.g., including input circuitry) 460, a memory 470, and a processor (e.g., including processing circuitry) 480.

The communication unit 410 may include various communication circuitry configured to perform communication in the electronic device 400. The communication unit 410 may communicate with an external device (not shown) through various communication schemes. The communication unit 410 may perform at least one of wireless communication and wired communication. To this end, the communication unit 410 may access at least one of a mobile communication network and a data communication network. For example, the external device may include an electronic device, a base station, a server, and a satellite. The communication schemes may include Long Term Evolution (LTE), Wideband Code Division Multiple Access (WCDMA), Global System for Mobile Communications (GSM), Wi-Fi, Bluetooth, and Near Field Communications (NFC).

The sensor unit 420 may sense a user's motion and transfer acquired sensing information to the processor 480. The sensor unit 420 may include a motion sensor 421, a proximity sensor 422, and a biometric sensor 423. Particularly, the motion sensor 421 may include an acceleration sensor, a gravity acceleration sensor, and a gyro sensor. The motion sensor 421 may transfer sensing information on the acceleration of gravity, an acceleration, and a rotation angle according to a motion of the electronic device 400 to the processor 480. The proximity sensor 422 may include an infrared sensor. The proximity sensor 422 may transfer sensing information on whether the user is in proximity to the electronic device 400 to the processor 480. When the user grips the electronic device 400, the proximity sensor 422 may be located at a position where user's fingers or palm contact. The biometric sensor 423 may acquire user's biometric information and transfer sensing information to the processor 480. The biometric sensor 423 may include a heartbeat sensor for measuring a user's heartbeat, a temperature sensor for measuring user's body temperature, and a vein sensor for measuring a user's vein. The biometric sensor 423 may measure the proximity of the user to the electronic device 400. According to an embodiment, when the biometric sensor 423 is a temperature sensor, it may be identified that the user is in the proximity of the electronic device 400 if the processor 480 detects body temperature higher than or equal to a predetermined value from sensing information received through the temperature sensor.

The camera 430 may be disposed at a particular position of the electronic device 400 and may acquire image data of a subject. To this end, the camera 430 may receive an optical signal. The camera 430 may generate image data from the optical signal. The camera 430 may include a camera sensor and a signal converter. The camera sensor may be included in the sensor unit 420. The camera sensor may convert the optical signal into an electric image signal. The signal converter may convert an analog image single into digital image data.

The image processing unit 440 may include various circuitry configured to process image data. The image processing unit 440 may process the image data in the unit of frames and output the image data in accordance with characteristics and the size of the display unit 450. The image processing unit 440 may compress the image data in a preset format or reconstruct the compressed image data to be the original image data. The image processing unit 440 may provide the image data which has been processed in the unit of frames, to the processor 480.

The display unit 450 may output a user interface. At this time, the user interface may be a screen including image data and a web browser, or a screen including an object (for example, an icon). The display unit 450 may include a Liquid Crystal Display (LCD), a Light Emitting Diode (LED) display, an Organic LED (OLED) display, a Micro Electro Mechanical System (MEMS) display, and an electronic paper display, or the like, but is not limited thereto. The display unit 450 may include a plurality of light emitting diodes. Further, the display unit 450 may be combined with the input unit 460 to be implemented as a touch screen. The display unit 450 implemented as the touch screen may transfer coordinate information on a motion detected on the surface of the display unit 450, that is, hovering or touch detected by a user's hand or finger to the processor 480.

The input unit 460 may include various input circuitry configured to generate input data in the electronic device 400. The input unit 460 may generate the input data in response to a user input of the electronic device 400. The input unit 460 may include at least one input means. The input unit 460 may include various input circuitry, such as, for example, and without limitation, a key pad, a dome switch, a physical button, a touch panel, and a jog & shuttle. Particularly, the touch panel may sense a motion on the touch panel, that is, coordinate information on hovering or touch detected by a user's finger and may transfer the sensed information to the processor 480.

The storage unit 470 may store operation programs of the electronic device 400. At this time, the memory 470 may store a program for controlling the user interface according to a user input. The memory 470 may store a function corresponding to a motion detected by the motion sensor 421 included in the sensor unit 420.

The processor 480 may include various processing circuitry configured to control an overall operation of the electronic device 400. The processor 480 may identify proximity of the user to the electronic device 400 through the proximity sensor 422 or the biometric sensor 423 and acquire a motion value corresponding to a motion of the electronic device 400 through the motion sensor 421 based on a result of the identification. The processor 480 may execute at least one function by using the acquired motion value. The processor 480 may display screen data including an execution screen of an application being executed or an idle screen on the display unit 450.

The processor 480 may detect whether a particular object approaches through the proximity sensor 422 or the biometric sensor 423 in a state where the screen data is displayed. When the proximity of the user to the electronic device 400 is detected, the processor 480 may activate the motion sensor 421. The processor 480 may recognize a motion of the electronic device 400 generated by the user through the motion sensor 421. The processor 480 may control the operation of the electronic device 400 based on the recognized motion. The processor 480 may control different operations in the same application according to the motion of the electronic device 400 detected by the gyro sensor or the acceleration sensor. The motion of the electronic device 400 controlled by the processor 480 may be as shown in the below Table.

TABLE 1

| | | | Acceleration |
|---|---|---|---|
| Application | Operation control | Gyro sensor | sensor |
| Gallery | Scroll, | Detecting y axis rotation: | Detecting z axis rotation: |
| | enlargement/reduction, | displaying previous/next | enlargement/reduction |
| | and maintaining | image | |
| | brightness of the | | |
| | display unit 450 | | |
| Map | Scroll, | Detecting y axis rotation: | Detecting z axis rotation: |
| application | enlargement/reduction, | changing layer mode | enlargement/reduction |
| | and maintaining | Detecting z axis rotation: | |
| | brightness of the | rotating in four cardinal | |
| | display unit 450 | directions | |
| Video player | Switching tab menus | Detecting y axis rotation: | Detecting x axis |
| | and controlling | displaying previous | rotation: fast |
| | buttons/events | video/next video | forward/rewind |
| Music player | Maintaining | Detecting y axis rotation: | Detecting x axis |
| | brightness of the | play previous | rotation: fast |
| | display unit 450 and | song/next song | forward/rewind |
| | controlling | | |
| | buttons/events | | |
| Web browser | Scroll, | Detecting y axis rotation: | Detecting z axis |
| | enlargement/reduction, | switching tab | rotation: |
| | and maintaining | | enlargement/reduction |
| | brightness of the | | |
| | display unit 450 | | |
| Keypad, lock | One hand mode | Detecting y axis rotation: | — |
| screen, | | one left/right hand keypad | |
| calculator | | Detecting z axis rotation: | |
| | | changing keyboard type | |
| Call | Controlling | Detecting y axis rotation: | — |
| reception | buttons/events and | receiving/rejecting call | |
| | scroll | Detecting x axis rotation: | |
| | | display call rejection | |
| | | message screen | |
| | | Scroll: selecting call | |
| | | rejection message | |
| Standby | Switching tab menus | Detecting y axis rotation: | — |
| screen | | switching tab menus | |
| | | Detecting x axis rotation: | |
| | | opening upper tab | |
| | | menus/opening task | |
| | | manager screen | |

When the electronic device 400 operates while being connected to an accessory device (not shown), the processor 480 may use sensing information acquired through the biometric sensor 423, for example, heartbeat information, temperature information, and vein information as authentication information for pairing with the accessory device.

The electronic device 400 according to an embodiment of the present disclosure may include at least one sensor of the proximity sensor 422 and the biometric sensor 423, the motion sensor 421, and the processor 480, and the processor 480 may be configured to identify the proximity of the user corresponding to the electronic device 400 through the sensor, to acquire a motion value corresponding a motion of the electronic device 400 through the motion sensor 421 based on the identification, and to execute at least one function based on the motion value.

The processor 480 may be configured to change at least a part of a user interface based on a speed, a direction, a size, and a change amount of the motion.

The processor 480 may be configured to move at least one content in a direction corresponding to a direction of the motion.

The processor 480 may execute a first function corresponding to the motion when the motion value meets a first condition, and execute a second function corresponding to the motion value when the motion value meets a second condition.

The processor 480 may be configured to perform a corresponding function between the first function and the second function while the proximity of the user is detected through the sensor.

When the proximity of the user is not detected through the sensor, the processor 480 may be configured to perform a third function.

The electronic device may further include the display unit 450, and the processor 480 may be configured to display screen data for an application being executed on the display unit 450.

When the proximity of the user is identified, the processor 480 may be configured to activate at least one motion sensor 421 which can acquire the motion value.

The processor 480 may be configured to identify a function allocated to the motion acquired through the motion sensor 421 and to perform the identified function.

The processor 480 may be configured to perform at least one function of scrolling the screen data, mobbing some areas of the screen data, enlarging and reducing the screen, and changing a menu in the application based on the motion.

When the motion is not acquired by the motion sensor 421, the processor 480 may be configured to maintain a brightness of the display unit 450 after a threshold time passes.

When the application is an application interworking with the sensor, the processor 480 may be configured to activate the sensor.

The biometric sensor 423 may include at least one of a heartbeat sensor, a temperature sensor, and a vein sensor, and the processor 480 is configured to be paired with an external electronic device based at least one piece of heartbeat information, temperature information, and vein information detected by the biometric sensor 423.

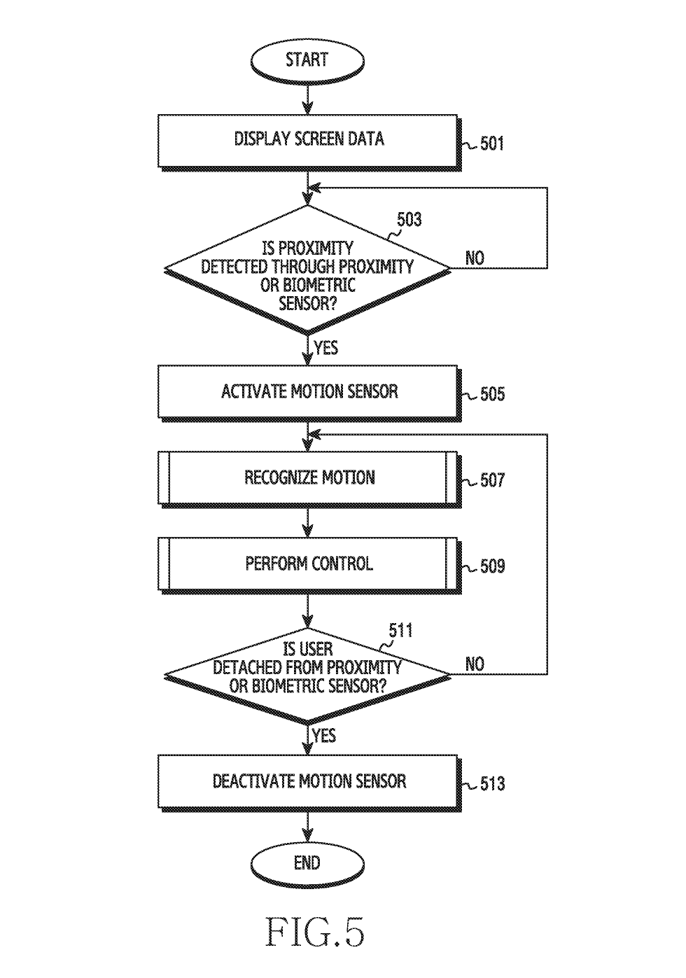

FIG. 5 is a flowchart illustrating an example method of operating an electronic device according to an example embodiment of the present disclosure.

Referring to FIG. 5, the electronic device 400 (for example, the processor 480) may display screen data including an execution screen of an application being executed and an idle screen on the display unit 450 in operation 501. The electronic device 400 (for example, the processor 480) may detect whether a particular object approaches through the proximity sensor 422 or the biometric sensor 423 in operation 503. The proximity sensor 422 may include an infrared sensor. According to an embodiment, the particular object may be a user's fingers. The proximity sensor 422 may be located on the rear surface of the electronic device 400 and, when the user grips the electronic device 400, may be located on at least one position where one of the user's fingers may contact.

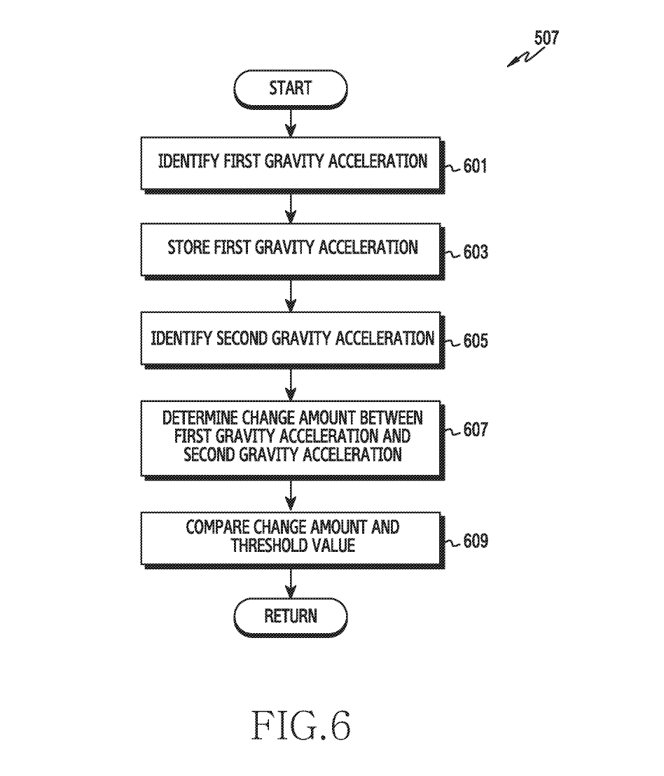

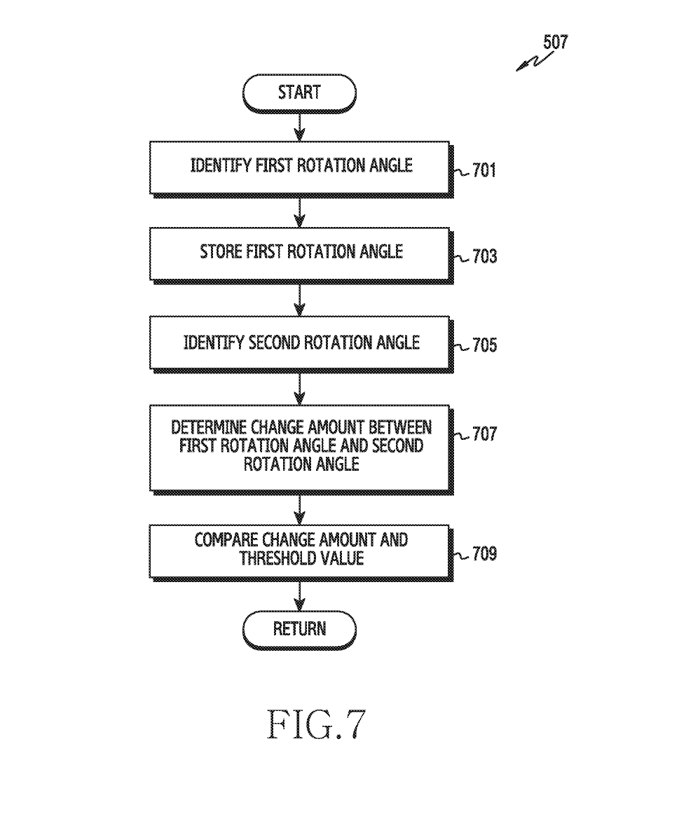

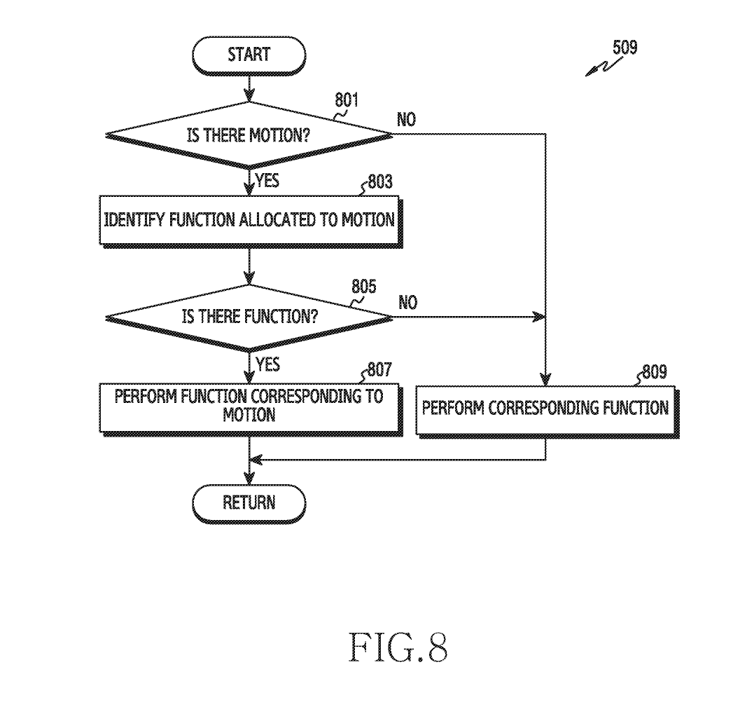

When the electronic device 400 (for example, the processor 480) detects the proximity of the in operation 503, the electronic device 400 (for example, the processor 480) may activate the motion sensor 421 in operation 505. The electronic device 400 (for example, the processor 480) may recognize a motion of the electronic device 400 generated by the user from the activated motion sensor 421 in operation 507. An operation of recognizing the motion of the electronic device 400 will be described in greater detail with reference to FIGS. 6 and 7. In operation 509, the electronic device 400 (for example, the processor 480) may perform a control of the electronic device 400 (for example, the processor 480) based on the motion recognized in operation 507. An operation of controlling the electronic device 400 (for example, the processor 480) will be described in greater detail with reference to FIG. 8.

The electronic device 400 (for example, the processor 480) may detect whether the existence or non-existence of the detachment of the user through the proximity sensor 422 or the biometric sensor 423 in operation 511. When the detachment of the user is detected through the proximity sensor 422 or the biometric sensor 423 based on a result of the identification of operation 511, the electronic device 400 (for example, the processor 480) may perform operation 513. In operation 513, the electronic device 400 (for example, the processor 480) may deactivate the motion sensor 421 activated in operation 505. According to an embodiment, the electronic device 400 (for example, the processor 480) may switch the motion sensor 421 to a low power mode or a sleep mode, and stop supplying power to the motion sensor 421 to switch the motion sensor 421 to an off state.

When the detachment of the user is not detected through the proximity sensor 422 or the biometric sensor 423 based on the result of the identification of operation 511, the electronic device 400 (for example, the processor 480) may return to operation 507. The electronic device 400 (for example, the processor 480) may recognize the motion of the electronic device 400 before the detachment of the user is detected and control the electronic device 400 based on the motion.

FIG. 6 is a flowchart illustrating an example method of recognizing a motion based on the gravity acceleration detected by the electronic device according to an example embodiment of the present disclosure.

According to an embodiment, referring to FIG. 6, when the motion sensor 421 is a gravity acceleration sensor, the electronic device 400 (for example, the processor 480) may identify a first gravity acceleration detected by the gravity acceleration sensor in operation 601. The electronic device 400 (for example, the processor 480) may store the identified first gravity acceleration in the memory 470 in operation 603. The first gravity acceleration corresponds to the gravity acceleration detected at a time point when the gravity acceleration sensor, which is the motion sensor 421, is activated, and may be the gravity acceleration before the motion of the electronic device 400 is generated. According to an embodiment, since the first gravity acceleration is a value detected at the time point when the gravity acceleration sensor is activated, the first gravity acceleration may be an initial value, for example, 9.8 m/s². The electronic device 400 (for example, the processor 480) may identify a second gravity acceleration detected by the gravity acceleration sensor in operation 605. The electronic device 400 (for example, the processor 480) may identify the second gravity acceleration periodically or in real time.

The electronic device 400 (for example, the processor 480) may determine change amounts of the first gravity acceleration and the second gravity acceleration in operation 607. The change amounts of the first gravity acceleration and the second gravity acceleration may be change amounts of the acceleration with respect to directions of x, y, and z axes. The electronic device 400 (for example, the processor 480) may compare the change amounts of first gravity acceleration and the second gravity acceleration with a threshold value in operation 609. After comparing the change amounts with the threshold value, the electronic device 400 (for example, the processor 480) may return to operation 509 of FIG. 5. Although the embodiment of the present disclosure describes an example in which the motion sensor 421 is the gravity acceleration sensor, the present disclosure is not necessarily limited thereto, and the motion sensor 421 may be an acceleration sensor.

FIG. 7 is a flowchart illustrating an example method of recognizing a motion based on a rotation angle detected by the electronic device according to an example embodiment of the present disclosure.

According to an example embodiment, referring to FIG. 7, when the motion sensor 421 is a gyro sensor, the electronic device 400 (for example, the processor 480) may identify a first rotation angle detected by the gyro sensor in operation 701. The electronic device 400 (for example, the processor 480) may store the identified first rotation angle in the memory 470 in operation 703. The first rotation angle corresponds to a rotation angle detected at a time point when the gyro sensor which is the motion sensor 421 is activated and may be rotation angle before the motion of the electronic device 400 is generated. The electronic device 400 (for example, the processor 480) may identify a second rotation angle detected by the gyro sensor in operation 705. The electronic device 400 (for example, the processor 480) may identify the second rotation angle periodically or in real time.

The electronic device 400 (for example, the processor 480) may determine change amounts of the first rotation angle and the second rotation angle in operation 707. The change amounts of the first rotation angle and the second rotation angle may be rotation change amounts of x, y, and z axes. The electronic device 400 (for example, the processor 480) may compare the determined change amounts with a threshold value in operation 709. After comparing the change amounts with the threshold, the electronic device 400 (for example, the processor 480) may return to operation 509 of FIG. 5. According to an embodiment of the present disclosure, although it is described that the change amounts are determined using the gravity acceleration and the rotation angle by the gravity acceleration sensor and the gyro sensor when the motion is recognized, the present disclosure is not necessarily limited thereto. The electronic device 400 (for example, the processor 480) may determine a change amount of the motion of the electronic device 400 by simultaneously using the gravity acceleration sensor and the gyro sensor when the motion is recognized.

FIG. 8 is a flowchart illustrating an example method of performing a control based on a motion recognized by the electronic device according to an example embodiment of the present disclosure.

According to an example embodiment, referring to FIG. 8, when it is identified that there is the motion of the electronic device 400 in operation 801, the electronic device 400 (for example, the processor 480) may perform operation 803. When it is identified that there is no motion of the electronic device 400 in operation 801, the electronic device 400 (for example, the processor 480) may perform operation 809. When it is identified that the change amount is larger than the threshold based on a result of the comparison between the change amount of the gravity acceleration or the rotation angle in FIG. 6 or 7 and the threshold value, the electronic device 400 (for example, the processor 480) may identify that there is the motion of the electronic device 400 in operation 801. When it is identified that the change amount is smaller than the threshold based on a result of the comparison between the change amount of the gravity acceleration or the rotation angle in FIG. 6 or 7 and the threshold value, the electronic device 400 (for example, the processor 480) may identify that there is no motion of the electronic device 400 in operation 801.

The electronic device 400 (for example, the processor 480) may identify a function allocated to the motion in operation 803. For example, the electronic device 400 (for example, the processor 480) may identify a function allocated to the change amount of the gravity acceleration larger than the threshold value. Further, the electronic device 400 (for example, the processor 480) may identify a function allocated to the change amount of the rotation angle larger than the threshold value. When there is the function allocated to the motion in operation 805, the electronic device 400 (for example, the processor 480) may perform operation 807.

The electronic device 400 (for example, the processor 480) may perform the function (for example, a first function or a second function) allocated to the motion in operation 807. For example, the function allocated to the motion may include controlling events such as enlarging/reducing screen data displayed on the display unit 450, scrolling the screen data, switching a tab menu, controlling brightness of the display unit 450, and receiving a call. When there is no function allocated to the motion in operation 805, the electronic device 400 (for example, the processor 480) may operation 809. The electronic device 400 (for example, the processor 480) may perform a corresponding function (for example, a third function). For example, the corresponding function may refer to a function corresponding to a touch input which is not the motion of the electronic device 400. According to an embodiment, the function allocated to the motion may vary depending on a degree of the motion, a pattern of the motion, a direction of the motion, or a speed of the motion. For example, when the user identifies a webpage, the electronic device 400 (for example, the processor 480) may change a scrolling speed according to a speed of the electronic device 400 moving downwardly. The electronic device 400 (for example, the processor 480) may detect the motion of the electronic device 400. When the electronic device 400 moves in a left direction, the electronic device 400 (for example, the processor 480) may perform a first function, for example, displaying a webpage linked to a webpage on the display unit 450. When the electronic device 400 moves in a right direction, the electronic device 400 (for example, the processor 480) may perform a second function, for example, displaying a controller which may control a webpage on the display unit 450.

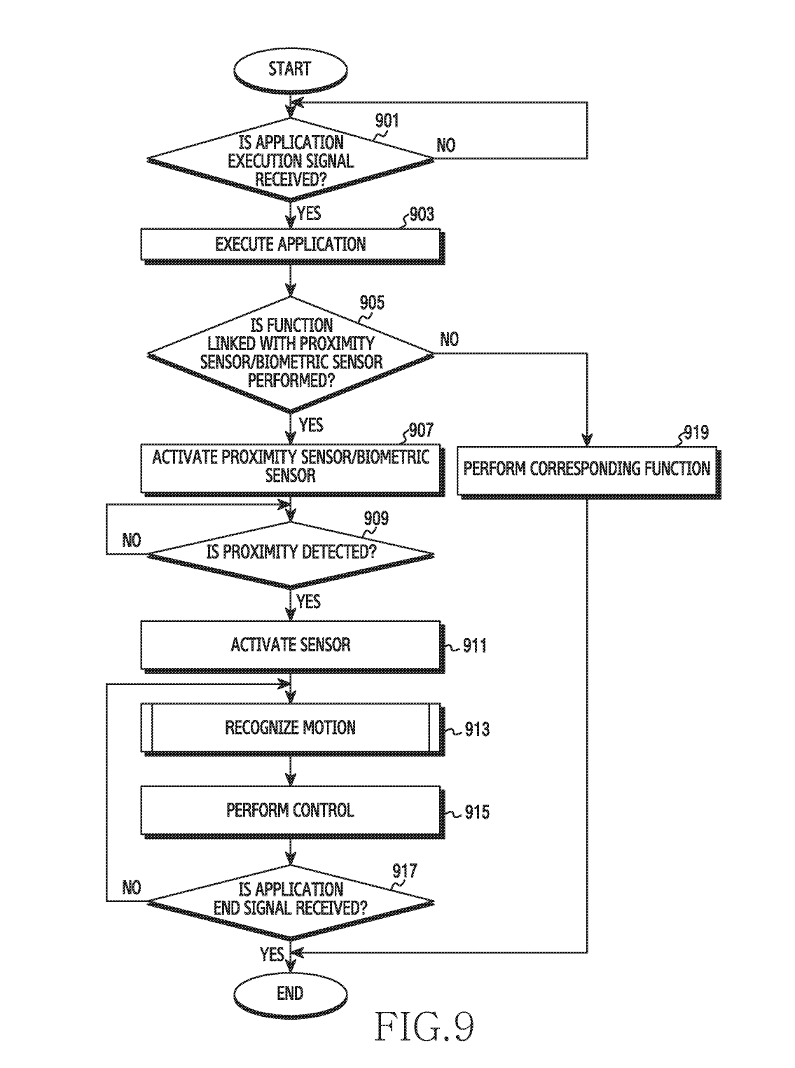

FIG. 9 is a flowchart illustrating an example method of operating an application when the electronic device executes the application according to an example embodiment of the present disclosure.

According to an embodiment, referring to FIG. 9, the electronic device 400 (for example, the processor 480) may receive an application execution signal in operation 901. The electronic device 400 (for example, the processor 480) may execute an application corresponding to the execution signal and display an execution screen of the application on the display unit 540 in operation 903 when an application execution signal is received in operation 901. The electronic device 400 (for example, the processor 480) may identify whether the executed application is an application that interworks with the proximity sensor 422 or the biometric sensor 423 in operation 905.

When the application is the application that interworks with the proximity sensor 422 or the biometric sensor 423 based on a result of the identification of operation 905, the electronic device 400 (for example, the processor 480) may perform operation 907. When the application is not the application that interworks with the proximity sensor 422 or the biometric sensor 423 based on a result of the identification of operation 905, the electronic device 400 (for example, the processor 480) may perform operation 919. The electronic device 400 (for example, the processor 480) may perform a corresponding function in operation 919. For example, the corresponding function may be a function corresponding to a touch input generated on the display unit 450 regardless of the motion of the electronic device 400 (for example, the processor 480).

The electronic device 400 (for example, the processor 480) may activate the proximity sensor 422 or the biometric sensor 423 in operation 907. When the proximity of the user to the proximity sensor 422 or the biometric sensor 423 is detected in operation 909, the electronic device 400 (for example, the processor 480) may perform operation 911. When the proximity of the user is not detected in operation 909, the electronic device 400 (for example, the processor 480) may repeatedly perform operation 909 for a threshold time or by a number of times corresponding to a threshold value.

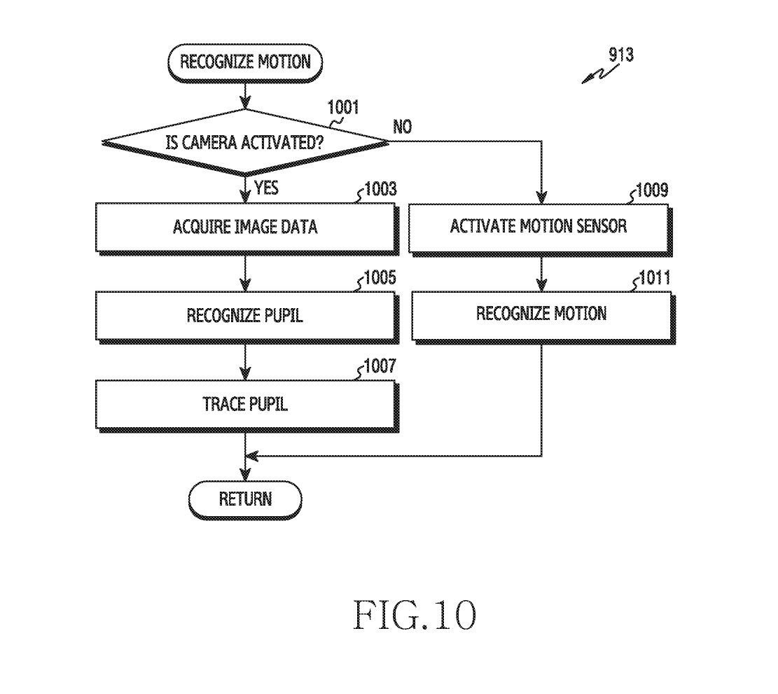

The electronic device 400 (for example, the processor 480) may activate a sensor in operation 911. For example, the electronic device 400 (for example, the processor 480) may activate the motion sensor 421 or the camera 430. When the executed application is an application that is executed by a motion from image data acquired by the camera 430, the electronic device 400 (for example, the processor 480) may activate the camera 430. When the executed application is an application that is executed by a motion from image data acquired by the motion sensor 421, the electronic device 400 (for example, the processor 480) may activate the motion sensor 421. The electronic device 400 (for example, the processor 480) may recognize the motion detected by the sensor in operation 913. Operation 913 will be described in greater detail with reference to FIG. 10.

The electronic device 400 (for example, the processor 480) may perform a control corresponding to the motion recognized in operation 913 in operation 915, which may be the same as operation 509 of FIG. 5. For example, the electronic device 400 (for example, the processor 480) may control events such as enlarging/reducing screen data displayed on the display unit 450, scrolling the screen data, switching the tab menu, controlling the brightness of the display unit 450, and receiving the call. When an end signal for the executed application is received in operation 917, the electronic device 400 (for example, the processor 480) may end the process. When the end signal for the executed application is not received in operation 917, the electronic device 400 (for example, the processor 480) may return to operation 913 and perform the operation.

FIG. 10 is a flowchart illustrating an example method of operating motion recognition in an executed application according to an example embodiment of the present disclosure.

According to an example embodiment, referring to FIG. 10, when the camera 430 is activated in operation 1001, the electronic device 400 (for example, the processor 480) may perform operation 1003. The electronic device 400 (for example, the processor 480) may continuously acquire image data through the activated camera 430 while the application is executed in operation 1003. The camera 430 may be located on the front surface of the electronic device 400 (for example, the processor 480) and may acquire image data for a user's face. The electronic device 400 (for example, the processor 480) may recognize the user's pupil in the image data in operation 1005. The electronic device 400 (for example, the processor 480) may trace the pupil based on the continuously acquired image data in the unit of frames in operation 1007 and recognize the traced pupil as the motion detected by the electronic device 400 (for example, the processor 480). The electronic device 400 (for example, the processor 480) may return to operation 915 of FIG. 9 and control the application based on a result of the trace of the pupil.

When the camera 430 is not activated in operation 1001, the electronic device 400 (for example, the processor 480) may perform operation 1009. The electronic device 400 (for example, the processor 480) may recognize the state where the motion sensor 421 is activated in operation 1009 and perform operation 1011. The electronic device 400 (for example, the processor 480) may recognize the motion detected by the activated motion sensor 421 in operation 1011. The electronic device 400 (for example, the processor 480) may return to operation 915 of FIG. 9 and control the application based on the recognized motion. Operation 1011 for recognizing the motion may be the same as operation 507 of FIG. 5.

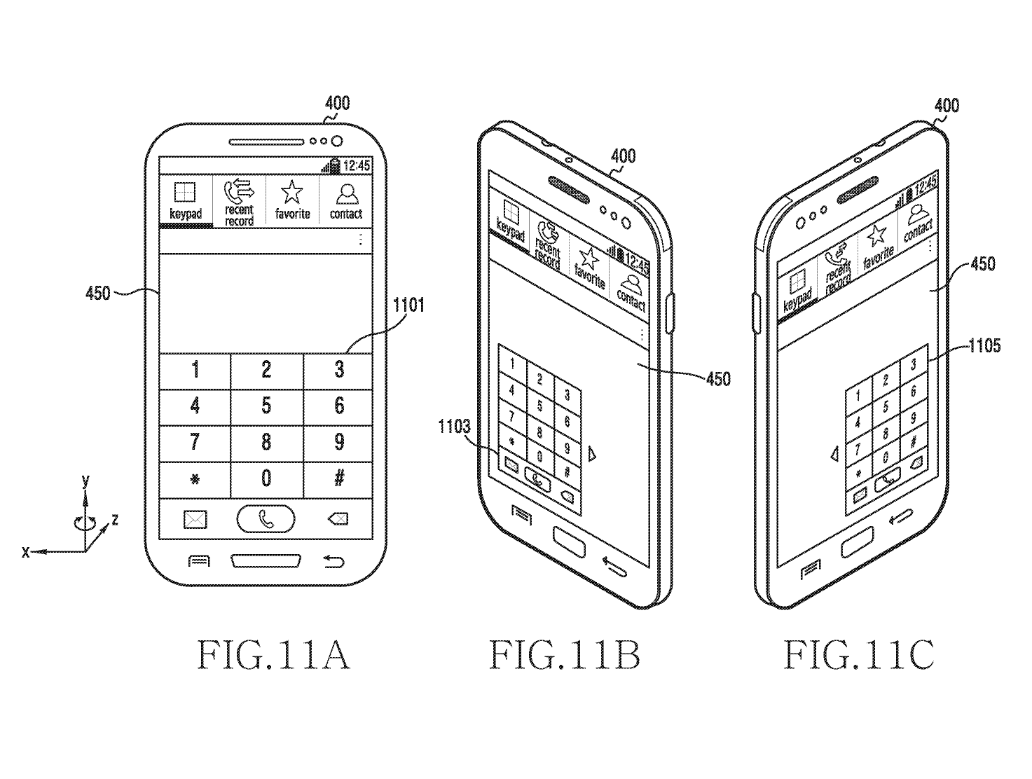

FIGS. 11A, 11B and 11C are diagrams illustrating examples of a screen for controlling a keypad based on a rotation angle of the electronic device according to an example embodiment of the present disclosure.

According to an example embodiment, referring to FIG. 11, the electronic device 400 (for example, the processor 480) may execute an application that may display a keypad for inputting a phone number on the display unit 450. The electronic device 400 (for example, the processor 480) may display a keypad 1101 on the display unit 450 as illustrated in FIG. 11A. When the proximity of the user is identified through the proximity sensor 422 or the biometric sensor 423, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 or the biometric sensor 423 and then, when the proximity of the user is identified, activate the motion sensor 421.

The electronic device 400 (for example, the processor 480) may identify a first rotation angle for x, y, and z axes through the motion sensor 421, for example, a gyro sensor in a state of FIG. 11A and store the first rotation angle in the memory 470. The electronic device 400 (for example, the processor 480) may detect the generation of a motion through the motion sensor 421. The electronic device 400 (for example, the processor 480) may identify a second rotation angle for x, y, and z axes of the electronic device 400 having the generated motion. The electronic device 400 (for example, the processor 480) may determine a change rate between the first rotation angle and the second rotation angle. When the change rate is larger than a threshold value, the electronic device 400 (for example, the processor 480) may perform a function corresponding to the detected motion.

The electronic device 400 (for example, the processor 480) may identify that the electronic device 400 rotates based on the y axis in a left direction as illustrated in FIG. 11B. When the electronic device 400 rotates in the left direction, the electronic device 400 (for example, the processor 480) may change a location of the keypad 1101 displayed on the display 450 as illustrated in FIG. 11A and display the keypad at the changed location. The electronic device 400 (for example, the processor 480) may change a location of a keypad 1103 in a left direction and display the keypad 1103 in the left side as illustrated in FIG. 11B. As described above, since the keypad 1103 is moved to the left side of the display unit 450, the user can easily control the keypad 1103 with one hand.

The electronic device 400 (for example, the processor 480) may identify that the electronic device 400 rotates based on the y axis in a right direction as illustrated in FIG. 11C. When the electronic device 400 rotates in the right direction, the electronic device 400 (for example, the processor 480) may change the location of the keypad 1101 displayed on the display unit 450 as illustrated in FIG. 11A and display the keypad 1101 at the changed location. The electronic device 400 (for example, the processor 480) may change a location of a keypad 1105 in a right direction and display the keypad 1105 in the right side of the display unit 450 as illustrated in FIG. 11C. As described above, since the keypad 1105 is moved to the right side of the display unit 450, the user can easily control the keypad 1105 with one hand.

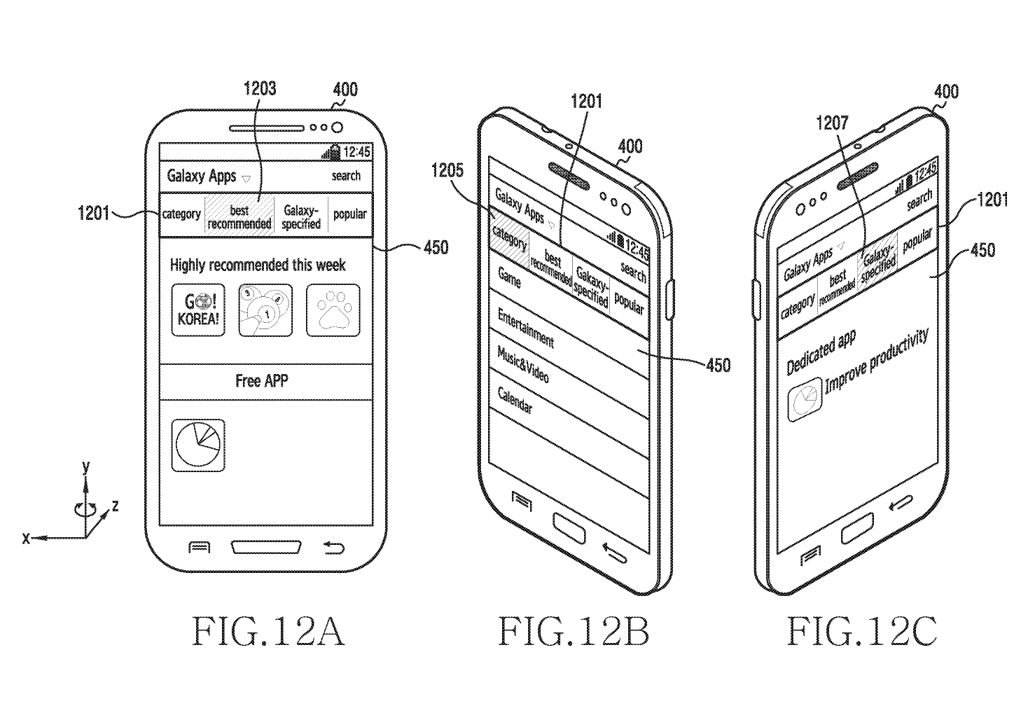

FIGS. 12A, 12B and 12C are diagrams illustrating examples of a screen for controlling tab menus based on a rotation angle of the electronic device according to an example embodiment of the present disclosure.

According to an example embodiment, referring to FIG. 12, the electronic device 400 (for example, the processor 480) may execute an app store and display screen data corresponding to the app store on the display unit 450 as illustrated in FIG. 12A. The screen data may be screen data in a state where a best recommended menu 1203 of tab menus 1201 provided by the app store is activated. When the proximity of the user is identified through the proximity sensor 422 or the biometric sensor 423, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 or the biometric sensor 423 and then, when the proximity of the user is identified, activate the motion sensor 421.

The electronic device 400 (for example, the processor 480) may identify a first rotation angle through the motion sensor 421 in a state of FIG. 12A and identify a second rotation angle of the electronic device 400 through the motion sensor 421. The electronic device 400 (for example, the processor 480) may perform a function corresponding to a motion detected based on a change rate between the first rotation angle and the second rotation angle.

The electronic device 400 (for example, the processor 480) may identify that the electronic device 400 (for example, the processor 480) rotates based on a y axis in a left direction as illustrated in FIG. 12B. When the electronic device 400 (for example, the processor 480) rotates in the left direction in a state where the best recommended menu 1203 is activated as illustrated in FIG. 12A, the electronic device 400 (for example, the processor 480) may switch the tap menus 1201 to a category menu 1205 and display the category menu 1205.

The electronic device 400 (for example, the processor 480) may identify that the electronic device 400 (for example, the processor 480) rotates based on the y axis in a right direction as illustrated in FIG. 12C. When the electronic device 400 (for example, the processor 480) rotates in the right direction in a state where the best recommended menu 1203 is activated as illustrated in FIG. 12A, the electronic device 400 (for example, the processor 480) may switch the tab menus 1201 to a Galaxy-specified menu 1207 and display the Galaxy-specified menu 1207.

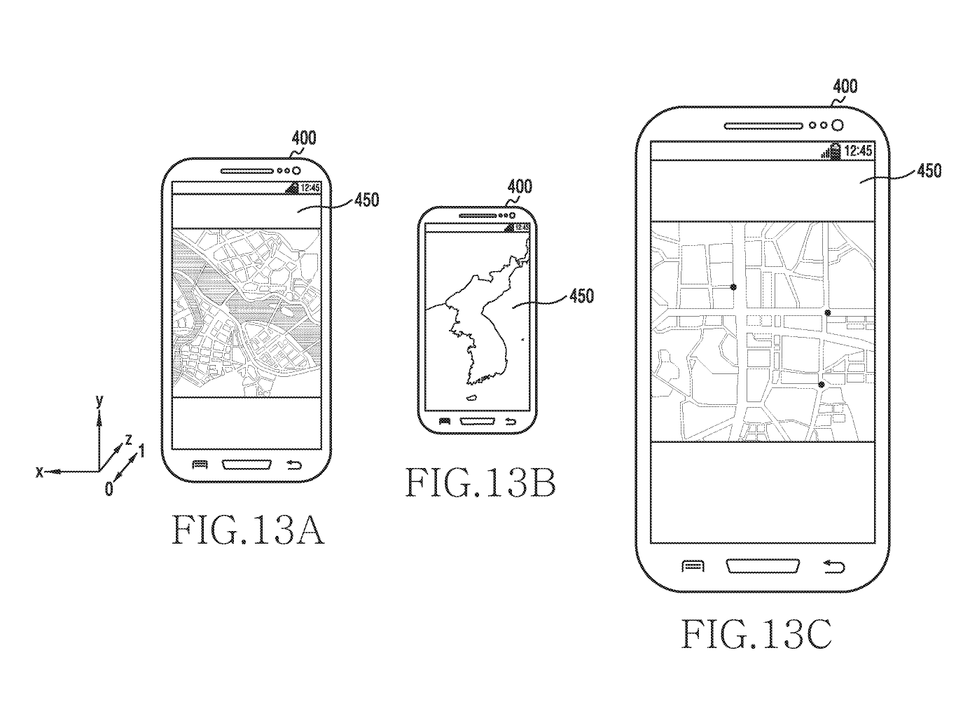

FIGS. 13A, 13B and 13C are diagrams illustrating examples of a screen for controlling map data based on the gravity acceleration of the electronic device according to an example embodiment of the present disclosure.

According to an example embodiment, referring to FIG. 13, the electronic device 400 (for example, the processor 480) may execute an application for displaying map data and display map data corresponding to the application on the display unit 450 as illustrated in FIG. 13A. The map data illustrated in FIG. 13A may be map data having a particular scale. When the proximity of the user is identified through the proximity sensor 422 or the biometric sensor 423, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 or the biometric sensor 423 and then, when the proximity of the user is identified, activate the motion sensor 421.

The electronic device 400 (for example, the processor 480) may identify a first acceleration size for x, y, and z axes in a state of FIG. 13A through the motion sensor 424, for example, the acceleration sensor and store the identified first acceleration in the memory 470. The electronic device 400 (for example, the processor 480) may identify a second acceleration size for x, y, and z axes of the electronic device 400 having the generated motion detected through the motion sensor 421. The electronic device 400 (for example, the processor 480) may perform a function corresponding to the detected motion according to a change rate between the first acceleration size and the second acceleration size.

The electronic device 400 (for example, the processor 480) may move in a direction of the z axis, that is, a direction of 1 as illustrated in FIG. 13B, and thus the electronic device 400 may become farther from the user. When the electronic device 400 is farther from the user in a state where the map data having the particular scale is displayed as illustrated in FIG. 13A, the electronic device 400 (for example, the processor 480) may increase the particular scale and display the map data having the increased scale (e.g., zoom out) as illustrated in FIG. 13B.

The electronic device 400 (for example, the processor 480) moves in a direction of the z axis, that is, in a direction of 0 as illustrated in FIG. 13C, and thus the electronic device 400 may become closer to the user. When the electronic device 400 is closer to the user in a state where the map data having the particular scale is displayed as illustrated in FIG. 13A, the electronic device 400 (for example, the processor 480) may decrease the particular scale (e.g., zoom in) and display the map data having the decreased scale as illustrated in FIG. 13C. When a volume up/down button is pressed after the proximity of the user is identified through the proximity sensor 422 or the biometric sensor 423, the electronic device 400 (for example, the processor 480) may increase/decrease the scale of the map data.

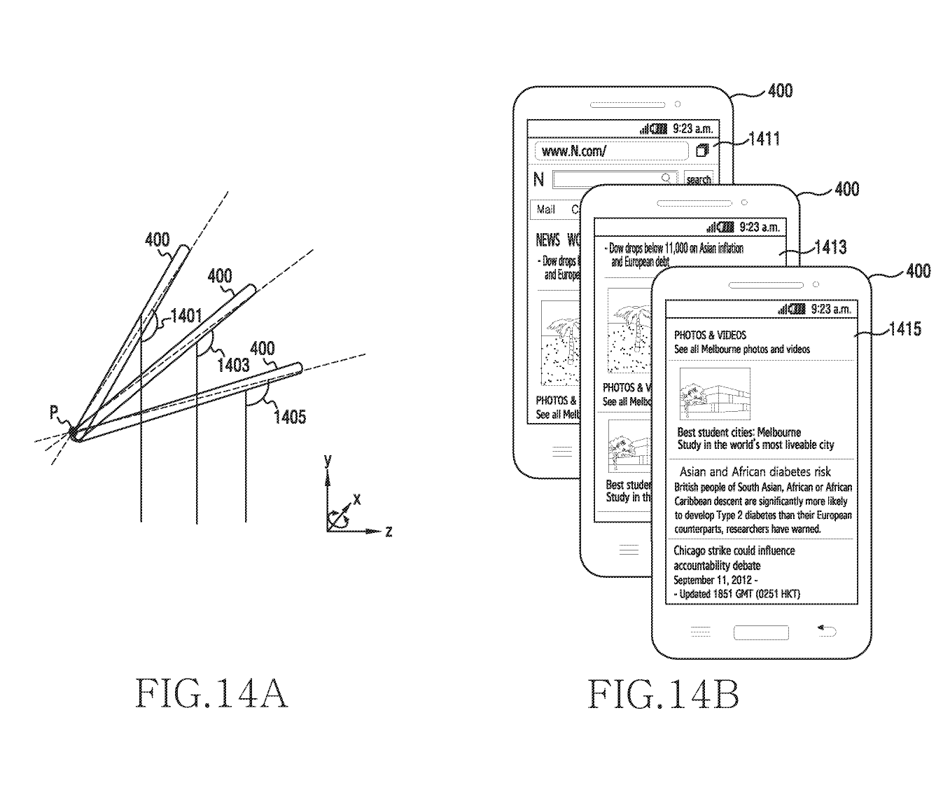

FIGS. 14A and 14B are diagrams illustrating examples of a screen for controlling a webpage upwardly and downwardly based on the gravity acceleration of the electronic device according to an example embodiment of the present disclosure.

According to an example embodiment, referring to FIG. 14, the electronic device 400 (for example, the processor 480) may identify that the electronic device 400 forms a first angle 1401 from the ground with respect to a reference point (P) in a state where the user grips the electronic device 400. In this state, the electronic device 400 (for example, the processor 480) may execute a particular website by a user input and display screen data for the executed website on the display unit 450. The electronic device 400 (for example, the processor 480) may display screen data 1411 on the display unit 450 as illustrated in FIG. 14B. FIG. 14A illustrates a state where the electronic device 400 is viewed from the right side or the left side. When the proximity of the user is identified through the proximity sensor 422 or the biometric sensor 423, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 and then, when the proximity of the user is identified, activate the motion sensor 421.

The electronic device 400 (for example, the processor 480) may identify a first gravity acceleration for x, y, and z axes when the angle from the ground corresponds to the first angle 1401 as illustrated in FIG. 14A through the motion sensor 421, for example, the gravity acceleration sensor and store the identified first gravity acceleration in the memory 470. The electronic device 400 (for example, the processor 480) may detect the generation of a motion of the electronic device 400 through the motion sensor 421. The electronic device 400 (for example, the processor 480) may identify a second gravity acceleration for x, y, and z axes of the electronic device 400 (for example, the processor 480) having the generated motion. The electronic device 400 (for example, the processor 480) may determine a change rate between the first gravity acceleration and the second gravity acceleration. When the change rate is larger than a threshold value, the electronic device 400 (for example, the processor 480) may perform a function corresponding to the detected motion.

The electronic device 400 (for example, the processor 480) may identify that the electronic device 400 generate the motion based on the x axis as illustrated in FIG. 14A and the gravity acceleration changes in a down direction. For example, the electronic device 400 (for example, the processor 480) may identify the generated motion of the electronic device 400 that forms a second angle 1403 from the ground with respect to the reference point (P). The electronic device 400 (for example, the processor 480) may scroll the screen data 1411 displayed on the display unit 450 and display the scrolled screen data as illustrated in FIG. 14B. For example, when the angle from the ground corresponds to the first angle 1401, the electronic device 400 (for example, the processor 480) may display screen data 1413 scrolled from the screen data 1411 displayed on the display unit 450 at a change rate with the second angle 1403.

The electronic device 400 (for example, the processor 480) may identify that the electronic device 400 generate the motion based on the x axis as illustrated in FIG. 14A and the gravity acceleration changes in a down direction. For example, the electronic device 400 (for example, the processor 480) may identify the generated motion of the electronic device 400 that forms a third angle 1405 from the ground with respect to the reference point (P). The electronic device 400 (for example, the processor 480) may scroll the screen data 1411 displayed on the display unit 450 and display the scrolled screen data as illustrated in FIG. 14B. For example, when the angle from the ground corresponds to the first angle 1401, the electronic device 400 (for example, the processor 480) may display screen data 1415 scrolled, from the screen data 1411 displayed on the display unit 450 at a change rate with the third angle 1405.

Although FIGS. 14A and 14B illustrate that, as an example, the screen data 1411 displayed on the display unit 450 is scrolled and displayed based on a change in the gravity acceleration for the generated motion of the electronic device 400, the present disclosure is not necessarily limited thereto. According to an embodiment, the electronic device 400 (for example, the processor 480) may identify a first rotation angle for the x axis through the motion sensor 421, for example, a gyro sensor when the angle from the ground corresponds to the first angle 1401 in FIG. 14A, and store the identified first rotation angle in the memory 470. The electronic device 400 (for example, the processor 480) may detect the generation of a motion of the electronic device 400 through the motion sensor 421.

The electronic device 400 (for example, the processor 480) may identify a second rotation angle for the x axis of the electronic device 400 (for example, the processor 480) having the generated motion. The electronic device 400 (for example, the processor 480) may determine a change rate between the first rotation angle and the second rotation angle. When the change rate is larger than a threshold value, the electronic device 400 (for example, the processor 480) may perform a function corresponding to the detected motion. The electronic device 400 (for example, the processor 480) may scroll the screen data 1411 displayed on the display unit 450 according to the change rate of the rotation angle and display the scrolled screen data as illustrated in FIG. 14B.

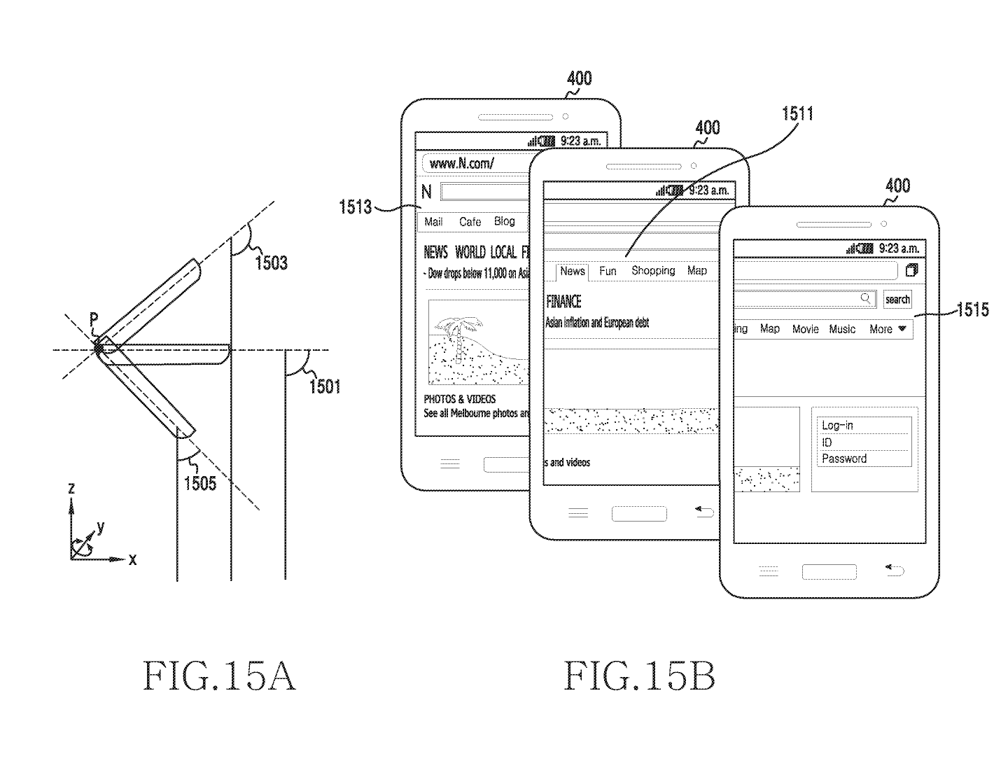

FIGS. 15A and 15B are diagrams illustrating examples of a screen for controlling a webpage in left and right directions based on the gravity acceleration of the electronic device according to an example embodiment of the present disclosure.

According to an example embodiment, referring to FIG. 15, the electronic device 400 (for example, the processor 480) may identify that the electronic device 400 forms a first angle 1501 from the ground with respect to a reference point (P) in a state where the user grips the electronic device 400. In this state, the electronic device 400 (for example, the processor 480) may execute a particular website by a user input and display screen data for the executed website on the display unit 450. The electronic device 400 (for example, the processor 480) may display screen data 1511 on the display unit 450 as illustrated in FIG. 15B. FIG. 15A illustrates a state where the electronic device 400 is viewed from the top or the bottom. When the proximity of the user is identified through the proximity sensor 422 or the biometric sensor 423, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 or the biometric sensor 423 and then, when the proximity of the user is identified, activate the motion sensor 421.

The electronic device 400 (for example, the processor 480) may identify a first gravity acceleration when the angle from the ground corresponds to a first angle 1501 in FIG. 15A through the motion sensor 421, for example, the gravity acceleration sensor and store the identified first gravity acceleration in the memory 470. The electronic device 400 (for example, the processor 480) may identify a second gravity acceleration of the electronic device 400 having the generated motion through the motion sensor 421. The electronic device 400 (for example, the processor 480) may perform a function corresponding to the motion according to a change rate between the first gravity acceleration and the second gravity acceleration.

The electronic device 400 (for example, the processor 480) may identify that the electronic device 400 moves in a direction of the y axis as illustrated in FIG. 15A and the gravity acceleration changes in a left direction. For example, the electronic device 400 (for example, the processor 480) may identify the generated motion of the electronic device 400 that forms a second angle 1503 from the ground with respect to the reference point (P). The electronic device 400 (for example, the processor 480) may scroll the screen data 1511 displayed on the display unit 450 and display the scrolled screen data as illustrated in FIG. 15B. For example, when the angle from the ground corresponds to the first angle 1501, the electronic device 400 (for example, the processor 480) may display screen data 1511 scrolled, by a change rate with the second angle 1503, from the screen data 1513 displayed on the display unit 450.

The electronic device 400 (for example, the processor 480) may identify that the electronic device 400 moves in a direction of the y axis as illustrated in FIG. 15A and the gravity acceleration changes in a right direction. For example, the electronic device 400 (for example, the processor 480) may identify the generated motion of the electronic device 400 that forms a third angle 1505 from the ground with respect to the reference point (P). The electronic device 400 (for example, the processor 480) may scroll the screen data 1511 displayed on the display unit 450 and display the scrolled screen data as illustrated in FIG. 15B. For example, when the angle from the ground corresponds to the first angle 1501, the electronic device 400 (for example, the processor 480) may display screen data 1511 scrolled, from the screen data 1515 displayed on the display unit 450 at a change rate with the third angle 1505.

Although FIGS. 15A and 15B illustrate that, as an example, the screen data 1511 displayed on the display unit 450 is scrolled and displayed based on a change in the gravity acceleration for the generated motion of the electronic device 400, the present disclosure is not necessarily limited thereto. According to an embodiment, the electronic device 400 (for example, the processor 480) may identify a first rotation angle for the y axis when the angle from the ground corresponds to the first angle 1501 in FIG. 15A through the motion sensor 421, for example, the gyro sensor and store the identified first rotation angle in the memory 470. The electronic device 400 (for example, the processor 480) may detect the generation of a motion of the electronic device 400 through the motion sensor 421.

The electronic device 400 (for example, the processor 480) may identify a second rotation angle for the y axis of the electronic device 400 (for example, the processor 480) having the generated motion. The electronic device 400 (for example, the processor 480) may determine a change rate between the first rotation angle and the second rotation angle. When the change rate is larger than a threshold value, the electronic device 400 (for example, the processor 480) may perform a function corresponding to the detected motion. The electronic device 400 (for example, the processor 480) may scroll the screen data 1511 displayed on the display unit 450 according to the change rate of the rotation angle and display the scrolled screen data as illustrated in FIG. 15B.

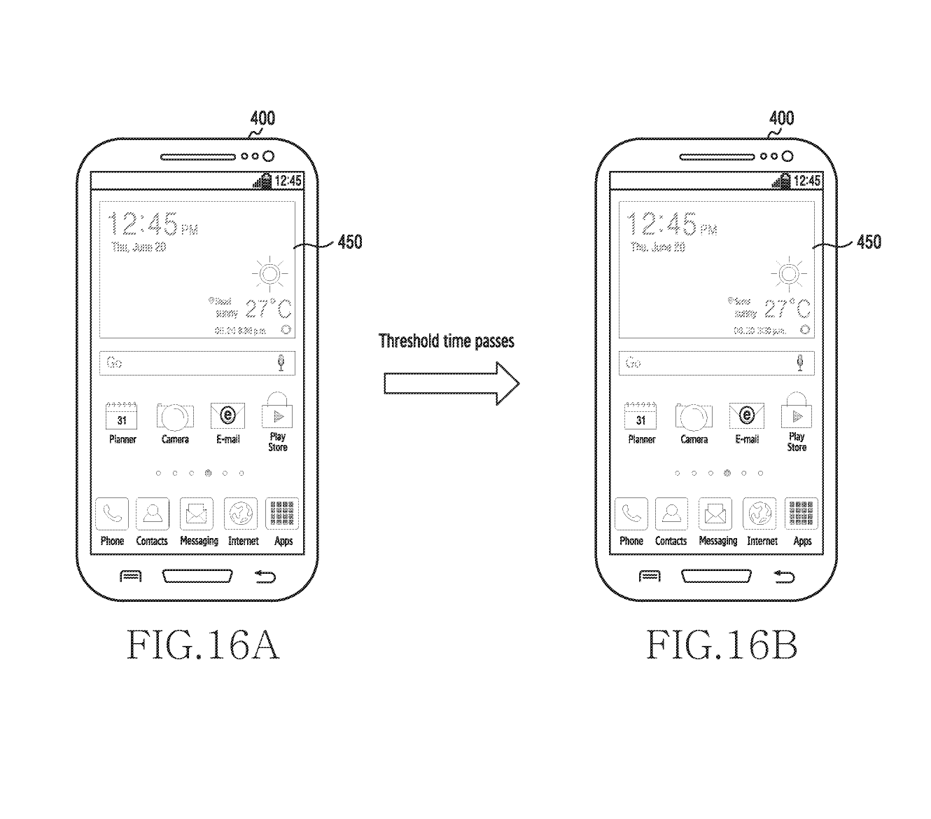

FIGS. 16A and 16B are diagrams illustrating examples of a screen for controlling brightness of the screen based on user proximity information detected by the electronic device according to an example embodiment of the present disclosure.

According to an example embodiment, referring to FIGS. 16A and 16B, the electronic device 400 (for example, the processor 480) may execute a particular application and display screen data for the application on the display unit 450 as illustrated in FIG. 16A. When the proximity of the user is identified, the electronic device 400 (for example, the processor 480) may activate the motion sensor 421. When the application is an application that interworks with the proximity sensor 422 or the biometric sensor 423, the electronic device 400 (for example, the processor 480) may activate the proximity sensor 422 or the biometric sensor 423 and then, when the proximity of the user is identified, activate the motion sensor 421. When the motion is not detected by the motion sensor 421, the electronic device 400 (for example, the processor 480) may maintain the same brightness of the display unit 450 illustrated in FIG. 16A even though a predetermined time passes as illustrated in FIG. 16B.

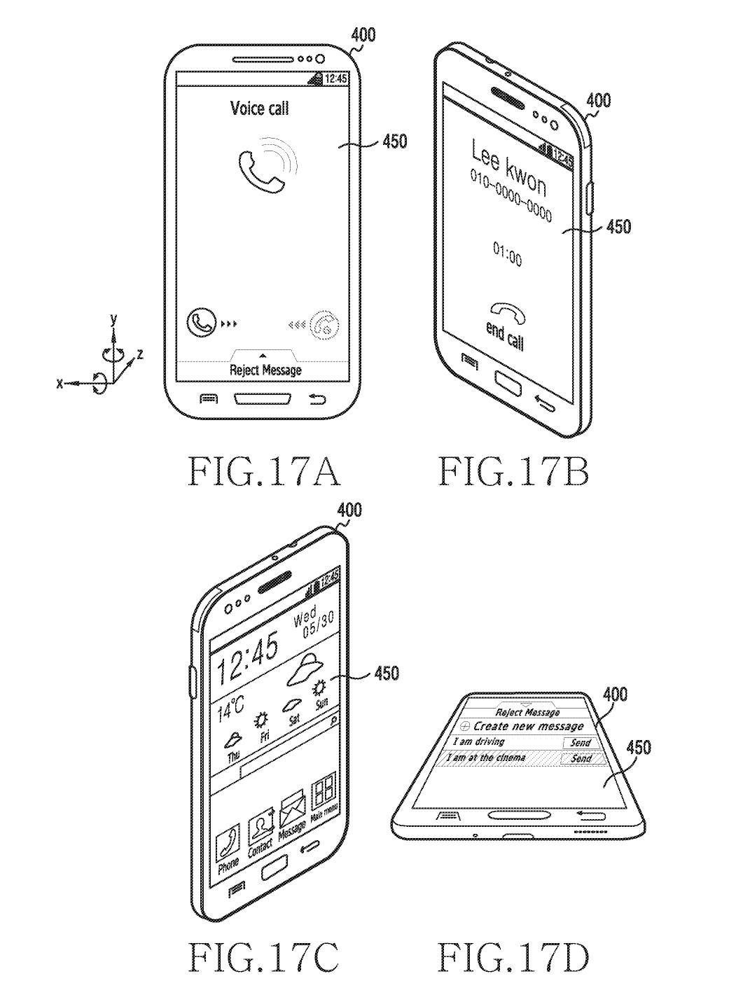

FIGS. 17A, 17B, 17C and 17D are diagrams illustrating examples of a screen for performing a function based on a rotation angle of the electronic device when a call is received according to an example embodiment of the present disclosure.

According to an example embodiment, referring to FIGS. 17A to 17D, when receiving a call, the electronic device 400 (for example, the processor 480) may display screen data illustrated in FIG. 17A on the display unit 450. When the proximity of the user is identified, the electronic device 400 (for example, the processor 480) may activate the motion sensor 421. When the call reception corresponds to a function that interworks the proximity of the user, the electronic device 400 (for example, the processor 480) may activate the proximity sensor 422 or the biometric sensor 423 and then, when the proximity of the user is identified, activate the motion sensor 421.

The electronic device 400 (for example, the processor 480) may identify a first rotation angle through the motion sensor 421, for example, the gyro sensor in a state of FIG. 17A and store the identified first rotation angle in the memory 470. The electronic device 400 (for example, the processor 480) may identify a second rotation angle for the electronic device 400 having the generated motion through the motion sensor 421. The electronic device 400 (for example, the processor 480) may perform a function corresponding to a motion detected according to change rates of the first rotation angle and the second rotation angle.

The electronic device 400 (for example, the processor 480) may identify that the electronic device 400 rotates on a y axis in a left direction as illustrated in FIG. 17B. When it is identified that the electronic device 400 rotates based on the y axis in the left direction, the electronic device 400 (for example, the processor 480) may respond to the received call. The electronic device 400 (for example, the processor 480) may display response screen data for the call as illustrated in FIG. 17B on the display unit 450 while responding to the received call.

The electronic device 400 (for example, the processor 480) may identify that the electronic device 400 rotates on the y axis in a right direction as illustrated in FIG. 17C. When it is identified that the electronic device 400 rotates based on the y axis in the right direction, the electronic device 400 (for example, the processor 480) may reject the received call. The electronic device 400 (for example, the processor 480) may display a standby screen on the display unit 450 as illustrated in FIG. 17C while rejecting the received call. The electronic device 400 (for example, the processor 480) may identify that the electronic device 400 rotates in a down direction based on an x axis after rejecting the call reception as illustrated in FIG. 17C. When it is identified that the electronic device 400 rotates in the down direction based on the x axis, the electronic device 400 (for example, the processor 480) may display screen data for selecting a call reception rejection message on the display unit 450 as illustrated in FIG. 17D. The electronic device 400 (for example, the processor 480) may highlight a predetermined message of a plurality of rejection messages according to the rotation direction on the x axis. When the detachment of the user is detected through the proximity sensor 422 in a state where a particular message is highlighted, the electronic device 400 (for example, the processor 480) may transmit the highlighted particular message to an electronic device corresponding to the rejected call.

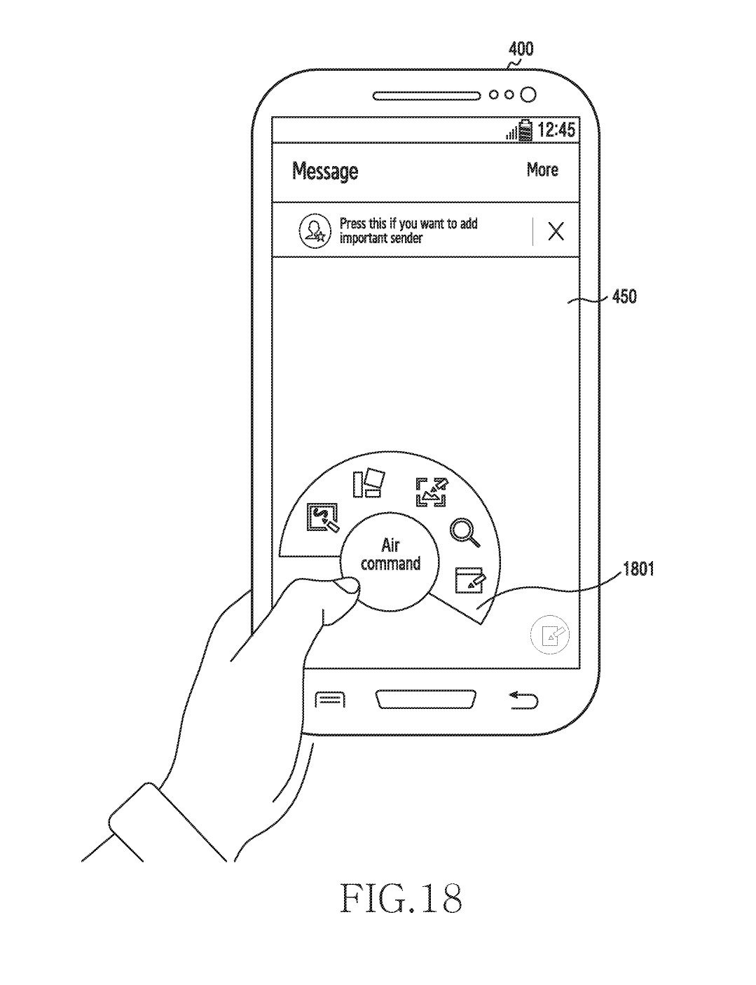

FIG. 18 is a diagram illustrating an example of a screen for displaying floating menus in the electronic device according to an example embodiment of the present disclosure.

According to an example embodiment, referring to FIG. 18, the electronic device 400 (for example, the processor 480) may display screen data for an application related to a message on the display unit 450 as illustrated in FIG. 18. When the proximity of the user is identified, the electronic device 400 (for example, the processor 480) may activate the motion sensor 421. When the application is an application that interworks with the proximity of the user, the electronic device 400 (for example, the processor 480) may activate the proximity sensor 422 or the biometric sensor 423. When the proximity of the user is identified, the electronic device 400 (for example, the processor 480) may activate the motion sensor 421. When a touch input is generated on the display unit 450 without any motion detected through the motion sensor 421, the electronic device 400 (for example, the processor 480) may identify a location of the generated touch input.

The electronic device 400 (for example, the processor 480) may display floating menus 1801 at the location of the generated touch input. The electronic device 400 (for example, the processor 480) may perform a function for a menu selected from the floating menus 1801. When a motion of the electronic device 400 (for example, the processor 480) is detected through the motion sensor 421 after the floating menus 1801 are displayed on the display unit 450, the electronic device 400 (for example, the processor 480) may change the location of the floating menus 1801.

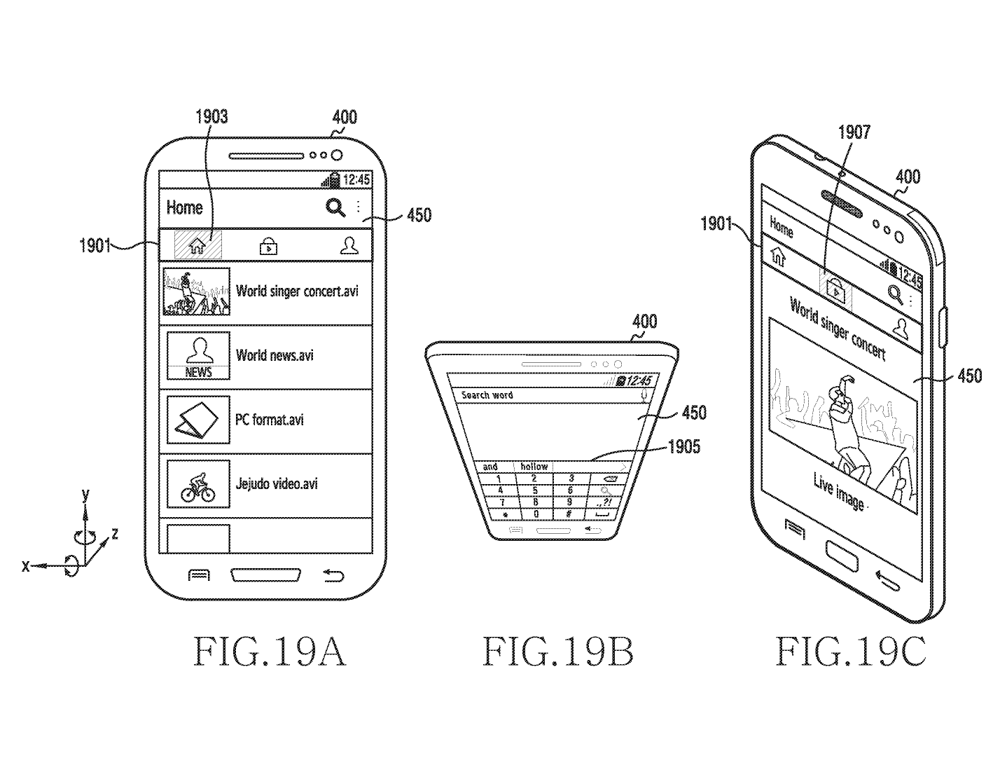

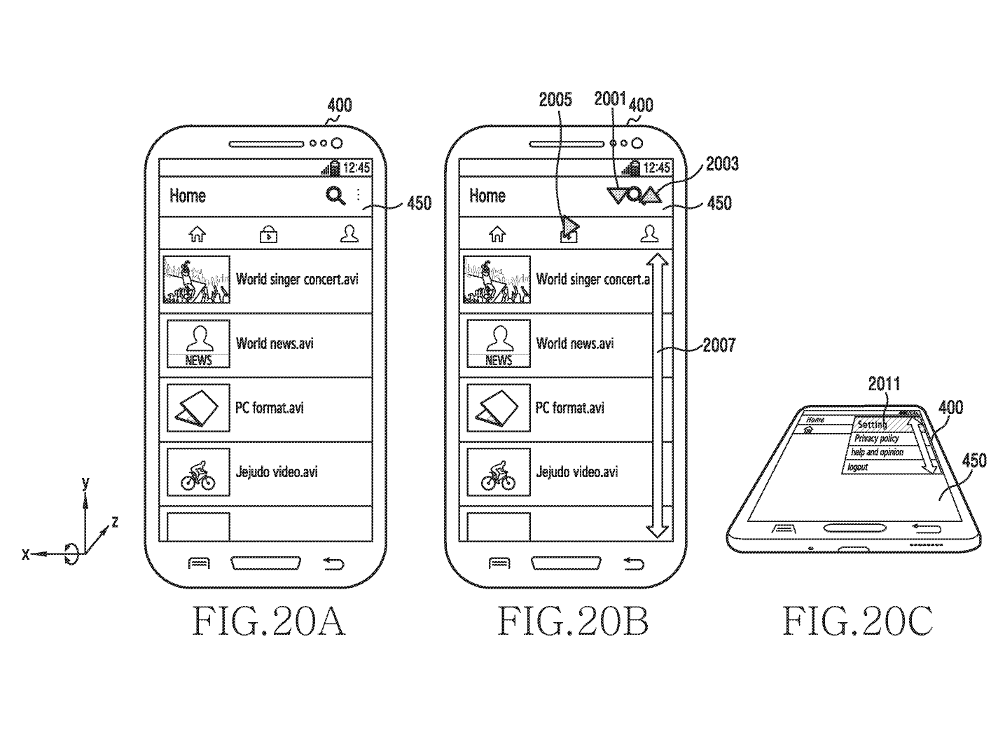

FIGS. 19A, 19B and 19C and FIGS. 20A, 20B and 20C are diagrams illustrating examples of a screen for controlling an executed application based on a rotation angle of the electronic device according to an example embodiment of the present disclosure.

According to an example embodiment, referring to FIGS. 19A to 19C and FIGS. 20A to 20C, the electronic device 400 (for example, the processor 480) may display screen data for a particular application on the display unit 450 as illustrated in FIG. 19A. The electronic device 400 (for example, the processor 480) may display screen data in a state where a home menu 1903 of tap menus 1901 provided by the application is activated. When the proximity of the user is identified, the electronic device 400 (for example, the processor 480) may activate the motion sensor 421. When the application is an application that interworks with the proximity of the user, the electronic device 400 (for example, the processor 480) may activate the proximity sensor 422 or the biometric sensor 423. When the proximity of the user is identified, the electronic device 400 (for example, the processor 480) may activate the motion sensor 421.

The electronic device 400 (for example, the processor 480) may identify a first rotation angle of the electronic device 400 through the motion sensor 421, for example, the gyro sensor in a state of FIG. 19A and store the identified first rotation angle in the memory 470. The electronic device 400 (for example, the processor 480) may identify a second rotation angle of the electronic device 400 (for example, the processor 480) having the generated motion through the motion sensor 421. The electronic device 400 (for example, the processor 480) may perform a function corresponding to the motion according to a change rate between the first rotation angle and the second rotation angle.

The electronic device 400 (for example, the processor 480) may identify that the electronic device 400 rotates on an x axis in an up direction as illustrated in FIG. 19B. When the electronic device 400 rotates based on the x axis in the up direction, the electronic device 400 (for example, the processor 480) may display a search box for searching for a particular item in the executed application and a keypad 1905 as illustrated in FIG. 19B. The electronic device 400 (for example, the processor 480) may identify that the electronic device 400 rotates in a left direction based on a y axis in a state where the search box and the keypad 1905 are displayed on the display unit 450. When it is identified that the electronic device 400 rotates based on the y axis in the left direction, the electronic device 400 (for example, the processor 480) may move and then display the keypad 1905 illustrated in FIG. 19B in the rotated direction.

The electronic device 400 (for example, the processor 480) may identify that the electronic device 400 rotates on the y axis in a left direction as illustrated in FIG. 19C. When the electronic device 400 rotates based on the y axis in the left direction, the electronic device 400 (for example, the processor 480) may change the selected home menu 1903 as illustrated in FIG. 19A to another tab menu 1907. The electronic device 400 (for example, the processor 480) may change the tab menus 1901 from the home menu 1903 to the other tab menu 1907 according to the rotation of the electronic device 400 and display screen data corresponding to the other tab menu 1907 on the display unit 450 as illustrated in FIG. 19C.

According to an example embodiment, the electronic device 400 (for example, the processor 480) may display screen data corresponding to a particular application on the display unit 450 as illustrated in FIG. 20A. When the proximity of the user is identified, the electronic device 400 (for example, the processor 480) may activate the motion sensor 421. When the application is an application that interworks with the proximity of the user, the electronic device 400 (for example, the processor 480) may activate the proximity sensor 422 or the biometric sensor 423. When the proximity of the user is identified, the electronic device 400 (for example, the processor 480) may activate the motion sensor 421. When the electronic device 400 (for example, the processor 480) identifies the proximity of the user for a predetermined time or longer through the proximity sensor 422 or the biometric sensor 423, the electronic device 400 (for example, the processor 480) may display a plurality of virtual arrows 2001, 2003, 2005, and 2007 on screen data displayed on the display unit 450 as illustrated in FIG. 20B.

The electronic device 400 (for example, the processor 480) may identify a first rotation angle through the motion sensor 421, for example, the gyro sensor in a state shown in FIG. 20A and store the identified first rotation angle in the memory 470. The electronic device 400 (for example, the processor 480) may identify a second rotation angle for the electronic device 400 having the generated motion through the motion sensor 421. The electronic device 400 (for example, the processor 480) may perform a function corresponding to the motion according to a change rate between the first rotation angle and the second rotation angle. When it is identified that the electronic device 400 rotates in a direction of one of the arrows 2001, 2003, 2005, and 2007 through the motion sensor 421, the electronic device 400 (for example, the processor 480) may perform a function corresponding to the arrow corresponding to the rotation.

The electronic device 400 (for example, the processor 480) may identify that the electronic device 400 rotates based on the x axis, for example, in a direction corresponding to the arrow 2001 or 2003 in a state where the proximity of the user is continuously detected through the proximity sensor 422 or the biometric sensor 423. When it is identified that the electronic device 400 rotates in the direction of the arrow 2003, the electronic device 400 (for example, the processor 480) may display detailed menus 2011 as illustrated in FIG. 20C. The electronic device 400 (for example, the processor 480) may highlight one of the items included in the detailed menus 2011, and change and display the highlighted item in the detailed menus 2011 according to the rotated direction on the x axis of the electronic device 400 (for example, the processor 480). When the detachment of the user is detected through the proximity sensor 422 in a state where a particular item of the detailed menus 2011 is highlighted, the electronic device 400 (for example, the processor 480) may perform a function corresponding to the highlighted item.

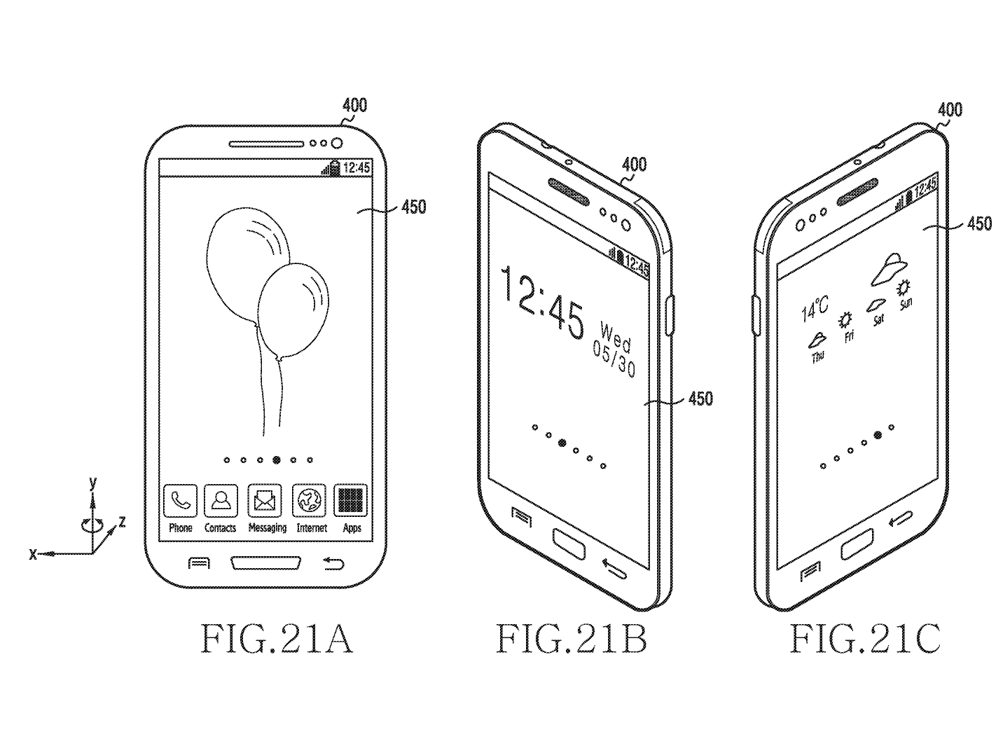

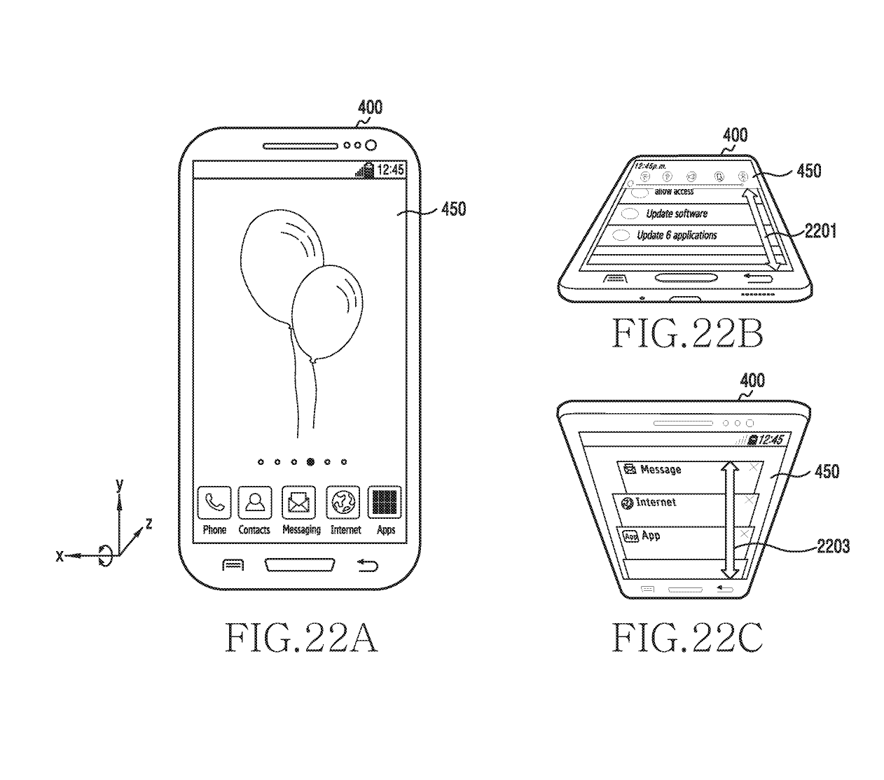

FIGS. 21A, 21B and 21C and FIGS. 22A, 22B and 22C are diagrams illustrating examples of a screen for controlling a background screen according to a rotation angle of the electronic device according to an example embodiment of the present disclosure.

According to an example embodiment, referring to FIGS. 21A to 21C and FIGS. 22A to 22C, the electronic device 400 (for example, the processor 480) may display a standby screen on the display unit 450 as illustrated in FIG. 21A. When the proximity of the user is identified, the electronic device 400 (for example, the processor 480) may activate the motion sensor 421. The electronic device 400 (for example, the processor 480) may identify a first rotation angle through the motion sensor 421, for example, the gyro sensor in a state of FIG. 21A and store the identified first rotation angle in the memory 470. The electronic device 400 (for example, the processor 480) may identify a second rotation angle for the electronic device 400 having the generated motion through the motion sensor 421. The electronic device 400 (for example, the processor 480) may perform a function corresponding to the motion according to a change rate between the first rotation angle and the second rotation angle.

The electronic device 400 (for example, the processor 480) may identify that the electronic device 400 (for example, the processor 480) rotates based on a y axis in a left direction as illustrated in FIG. 21B. When the electronic device 400 rotates in the left direction, the electronic device 400 (for example, the processor 480) may change the standby screen to a left tab and display the left tab as illustrated in FIG. 21B. The electronic device 400 (for example, the processor 480) may identify that the electronic device 400 (for example, the processor 480) rotates based on the y axis in a right direction as illustrated in FIG. 21C. When the electronic device 400 rotates in the right direction, the electronic device 400 (for example, the processor 480) may change the standby screen to a right tab and display the right tab as illustrated in FIG. 21C.

According to an embodiment, the electronic device 400 (for example, the processor 480) may display a standby screen on the display unit 450 as illustrated in FIG. 22A. When the proximity of the user is identified, the electronic device 400 (for example, the processor 480) may activate the motion sensor 421. The electronic device 400 (for example, the processor 480) may identify a first rotation angle through the motion sensor 421, for example, the gyro sensor in a state of FIG. 22A and store the identified first rotation angle in the memory 470. The electronic device 400 (for example, the processor 480) may identify a second rotation angle for the electronic device 400 having the identified motion through the motion sensor 421. The electronic device 400 (for example, the processor 480) may perform a function corresponding to the motion according to a change rate between the first rotation angle and the second rotation angle.

The electronic device 400 (for example, the processor 480) may identify that the electronic device 400 (for example, the processor 480) rotates based on an x axis in an up direction as illustrated in FIG. 22B. When the electronic device 400 rotates in the up direction, the electronic device 400 (for example, the processor 480) may display a notification window on the display unit 450 as illustrated in FIG. 22B. The electronic device 400 (for example, the processor 480) may perform a scroll 2201 to select a list in the notification window according to the rotated direction of the electronic device 400 based on the x axis in a state where the notification window is displayed on the display unit 450. When the detection of the proximity of the user ends, the electronic device 400 (for example, the processor 480) may select one item from the lists of the notification window.

The electronic device 400 (for example, the processor 480) may identify that the electronic device 400 (for example, the processor 480) rotates based on the x axis in a down direction as illustrated in FIG. 22C. When the electronic device 400 rotates in the down direction, the electronic device 400 (for example, the processor 480) may display a recently executed application list on the display unit 450 as illustrated in FIG. 22C. The electronic device 400 (for example, the processor 480) may perform a scroll 2203 may perform a scroll to select a particular application from the applications according to the rotated direction of the electronic device 400 based on the x axis in a state where the application list is displayed on the display unit 450. When the detection of the proximity of the user ends, the electronic device 400 (for example, the processor 480) may select one application from the application list and execute the selected application.

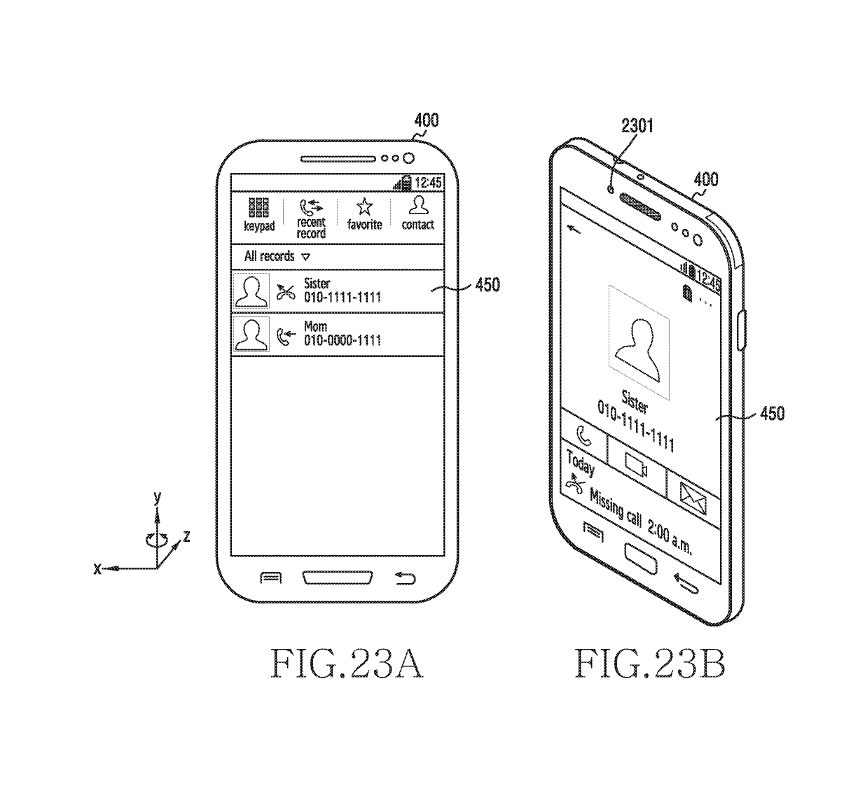

FIGS. 23A and 23B are diagrams illustrating examples of a screen for controlling call origination based on a rotation angle of the electronic device according to an example embodiment of the present disclosure.

According to an example embodiment, referring to FIG. 23, the electronic device 400 (for example, the processor 480) may display a call list screen on the display unit 450 as illustrated in FIG. 23A. When the proximity of the user is identified, the electronic device 400 (for example, the processor 480) may activate the motion sensor 421. The electronic device 400 (for example, the processor 480) may identify a first rotation angle through the motion sensor 421, for example, the gyro sensor in a state of FIG. 23A and store the identified first rotation angle in the memory 470. The electronic device 400 (for example, the processor 480) may identify a second rotation angle for the electronic device 400 having the generated motion through the motion sensor 421. The electronic device 400 (for example, the processor 480) may perform a function corresponding to the motion according to a change rate between the first rotation angle and the second rotation angle.

The electronic device 400 (for example, the processor 480) may identify that the electronic device 400 (for example, the processor 480) rotates based on a y axis in a left direction as illustrated in FIG. 23B. When the electronic device 400 rotates in the left direction, the electronic device 400 (for example, the processor 480) may display in detail a missing call item located on the top of missing call lists included in call lists as illustrated in FIG. 23B. The electronic device 400 (for example, the processor 480) may identify the proximity of the user through another proximity sensor 2301 located on the front surface of the electronic device 400 on the screen that displays the missing call item as illustrated in FIG. 23B.

When the proximity of the user is identified through the other proximity sensor 2301, the electronic device 400 (for example, the processor 480) may originate a call to a particular counterpart included in the screen data. When the detachment of the user is detected through the proximity sensor 422 or the biometric sensor 423 during the call origination to a particular counterpart, the electronic device 400 (for example, the processor 480) may end the call origination. Although the embodiment of the present disclosure describes an example in which the call is originated to the particular counterpart through the screen for identifying the missing call, the call may be originated to the particular counterpart through a screen for identifying a text message or a screen for identifying a Social Network System (SNS) notification for the particular user.

According to an embodiment of the present disclosure, a method of operating the electronic device 400 may include an operation of displaying screen data, an operation of identifying proximity of a user through at least one sensor between the proximity sensor 422 and the biometric sensor 423, an operation of detecting a motion of the electronic device 400 through the motion sensor 421 when the proximity of the user is identified, and an operation of executing at least one function corresponding to the motion.

The operation of displaying the screen data may be an operation of displaying screen data for an application being executed. The operation of displaying the screen data may further include an operation of identifying whether the application is an application interworking with the sensor and an operation of activating the sensor.

The operation of detecting the motion may include an operation of activating the motion sensor 421 when the proximity of the user is identified. The operation of detecting the motion may include an operation of identifying first sensing information when the motion sensor 421 is activated, an operation of identifying second sensing information corresponding to the motion when the motion is detected, and an operation of determining a change value between the first sensing information and the second sensing information.

The operation of executing the at least one function may include an operation of identifying whether there is a function corresponding to the determined change value and an operation of executing the function when the function exists.

The operation of executing the function may include an operation of executing at least one function of scrolling the screen data, mobbing some areas of the screen data, enlarging and reducing the screen, and changing a menu in the application based on the change value.

The operation of executing the at least one function may include an operation of, when the function does not exist, controlling a brightness of the display unit 450 displaying the screen data even after a threshold time passes.

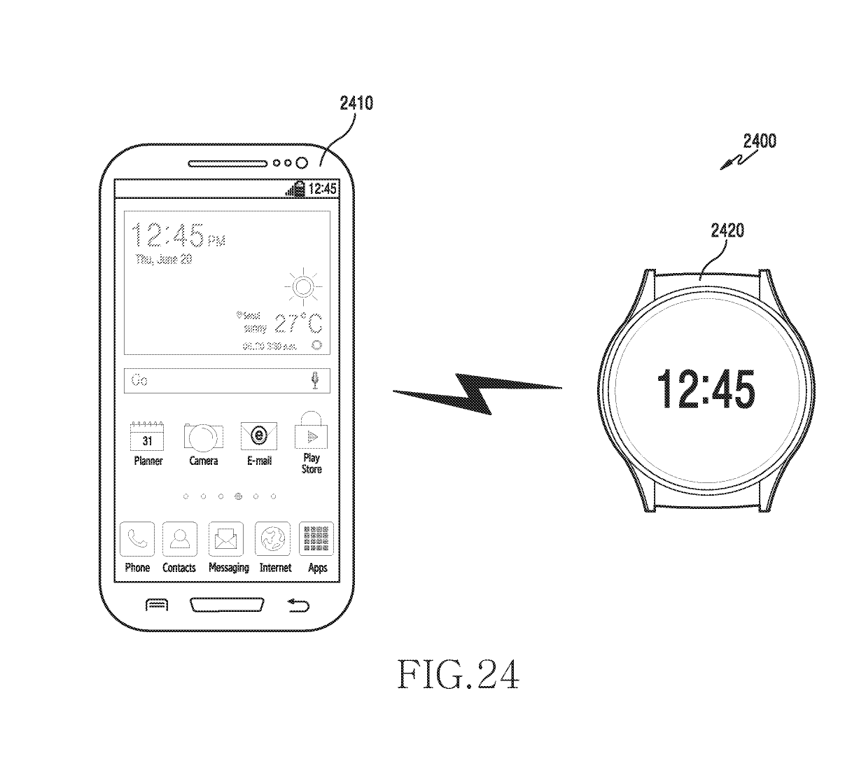

FIG. 24 is a diagram illustrating an example system including an electronic device and an accessory device according to another example embodiment of the present disclosure.

According to an example embodiment, referring to FIG. 24, a system 2400 according to an embodiment of the present disclosure may include an electronic device 2410 and an accessory device 2420.

The electronic device 2410 may include the same elements as those of the electronic device 400 illustrated in FIG. 4. Accordingly, a detailed description for the elements of the electronic device 2410 is replaced with the description for the elements of the electronic device 400. When a pairing request signal with the accessory device 2420 is input by the user, the electronic device 2410 (for example, the processor 480) may be paired with the accessory device 2420. The electronic device 2410 (for example, the processor 480) may identify user's heartbeat information through the biometric sensor 423. The electronic device 2410 (for example, the processor 480) may receive the heartbeat information from the accessory device 2420 through short-range wireless communication such as BLE with the accessory device 2420.

The electronic device 2410 (for example, the processor 480) may compare the heartbeat information acquired by the biometric sensor 423 with the heartbeat information received by the accessory device 2420 and, when the two pieces of heartbeat information are the same, complete the pairing with the accessory device 2420. The electronic device 2410 (for example, the processor 480) may store an identification number of the accessory device 2420 with which the electronic device 2410 (for example, the processor 480) has completed the pairing, and pairing information, for example, heartbeat information. When the pairing with the accessory device 2420 is completed, the electronic device 2410 (for example, the processor 480) may activate the motion sensor 421. The electronic device 2410 (for example, the processor 480) may control the operation of the electronic device 2410 based on a motion of the electronic device 2410 received through the motion sensor 421. Since it has been described in detail with reference to FIGS. 5 to 22, a detailed description thereof will be omitted.

When a pairing request signal with the electronic device 2410 is input by the user, the accessory device 2420 may acquire user's heartbeat information through a heartbeat sensor included in the accessory device 2420. The accessory device 2420 may transmit the acquired heartbeat information to the electronic device 2410 through short-range wireless communication such as BLE. When the pairing with the electronic device 2410 is completed, the accessory device 2420 may deactivate the short-range wireless communication. The accessory device 2420 may transmit heartbeat information to the electronic device 2410 with which the accessory device 2420 has completed the pairing in real time or periodically.

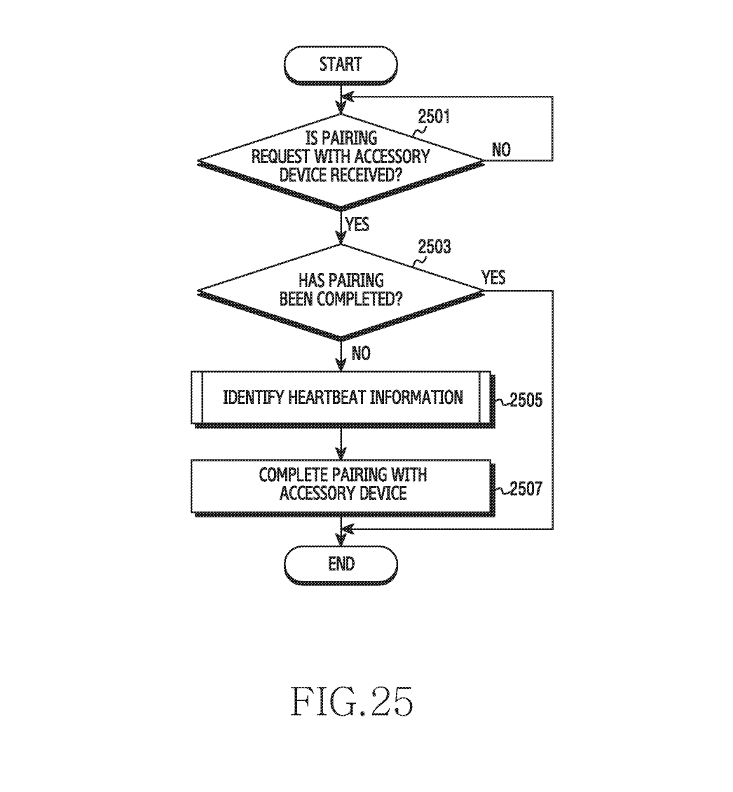

FIG. 25 is a flowchart illustrating an example operation in which the electronic device is paired with the accessory device according to another example embodiment of the present disclosure.

Referring to FIG. 25, when a pairing request signal with the accessory device 2420 is received from the user in operation 2501, the electronic device 2410 (for example, the electronic device 400 (for example, the processor 480)) may perform operation 2503. When the pairing request signal is not received, the electronic device 2410 (for example, the processor 480) may wait for receiving the pairing request signal. The electronic device 2410 (for example, the processor 480) may identify whether the pairing with the accessory device 2420 has been completed in operation 2503. When the pairing with the accessory device 2420 has been completed based on a result of the identification of operation 2503, the electronic device 2410 (for example, the processor 480) may end the process related to the pairing.

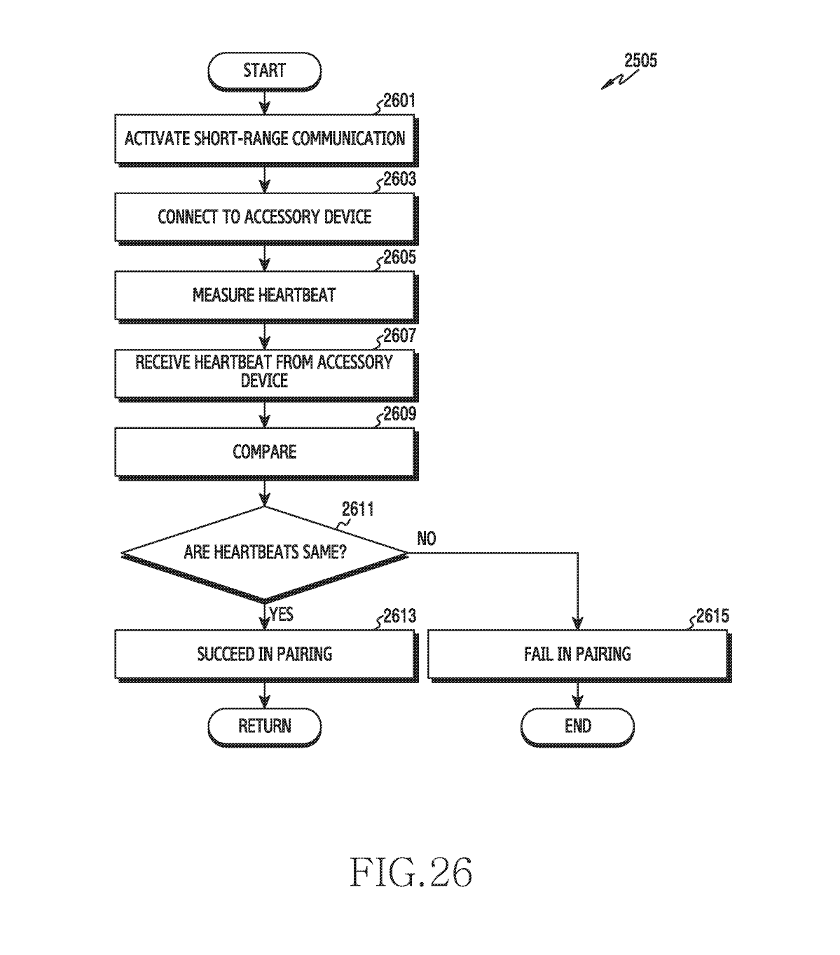

When the pairing with the accessory device 2420 has not been completed based on a result of the identification of operation 2503, the electronic device 2410 (for example, the processor 480) may perform operation 2505. The electronic device 2410 (for example, the processor 480) may identify user's heartbeat information in operation 2505. Operation 2505 will be described in greater detail with reference to FIG. 26. The electronic device 2410 (for example, the processor 480) having identified the user's heartbeat information may perform operation 2507. The electronic device 2410 (for example, the processor 480) may complete the pairing with the accessory device 2420 in operation 2507. The electronic device 2410 (for example, the processor 480) having completed the pairing with the accessory device 2420 may store information on the pairing with the accessory device 2420.

The electronic device 2410 (for example, the processor 480) may control screen data displayed on the display unit (for example, the display unit 450) of the electronic device 2410 (for example, the processor 480) through interworking with the accessory device 2420 with the electronic device 2410 (for example, the processor 480) has completed the pairing. For example, the electronic device 2410 (for example, the processor 480) may receive information on the proximity of the user to the biometric sensor periodically or in real time from the accessory device 2420. The biometric sensor may be included in the accessory device 2420. The biometric sensor may be a heartbeat sensor, a temperature sensor, and a vein sensor. The electronic device 2410 (for example, the processor 480) may detect a motion generated in the electronic device 2410 through the motion sensor 421 included in the electronic device 2410 (for example, the processor 480) in a state where the user is in proximity to the biometric sensor. The electronic device 2410 (for example, the processor 480) may control the electronic device 2410 (for example, the processor 480) in accordance with the detected motion. Since an embodiment for controlling the electronic device 2410 in accordance with the motion of the electronic device 2410 has been described in detail with reference to FIGS. 5 to 22, a detailed description thereof will be omitted.

FIG. 26 is a flowchart illustrating an example operation in which the electronic device performing pairing based on heartbeat information of the accessory device according to another example embodiment of the present disclosure.

Referring to FIG. 26, the electronic device 2410 (for example, the processor 480) may activate short-range communication to receive heartbeat information from the accessory device 2420 in operation 2601. The short-range communication may be BLE communication. The electronic device 2410 (for example, the processor 480) may be wirelessly connected to the accessory device through short-range communication in operation 2603. The electronic device 2410 (for example, the processor 480) may measure user's heartbeat information in operation 2605. The electronic device 2410 (for example, the processor 480) may measure the user's heartbeat information by activating the biometric sensor 423 included in the sensor unit 420 to measure the heartbeat information. The electronic device 2410 (for example, the processor 480) may acquire image data for a user's face for a predetermined time by activating the camera 430 located on the front surface of the electronic device 2410. The electronic device 2410 (for example, the processor 480) may analyze the user's face within the acquired image data and identify a change in a color of the analyzed face. The electronic device 2410 (for example, the processor 480) may acquire heartbeat information based on the color change.

The electronic device 2410 (for example, the processor 480) may receive the heartbeat information from the accessory device 2420 in operation 2607. The accessory device 2420 may acquire the user's heartbeat information through the biometric sensor included in the accessory device 2420. The electronic device 2410 (for example, the processor 480) may compare the heartbeat information acquired by the electronic device 2410 with the heartbeat information received from the accessory device 2420 in operation 2609.

When the two pieces of heartbeat information are the same based on a result of the comparison between the two pieces of heartbeat information in operation 2611, the electronic device 2410 (for example, the processor 480) may perform operation 2613. Since it may be identified that a user of the electronic device 2410 and a user of the accessory device 2420 are the same, the electronic device 2410 (for example, the processor 480) may identify that the pairing between the two devices is successful in operation 2613. When the pairing between the two devices is successful, the electronic device 2410 (for example, the processor 480) may return to operation 2507 of FIG. 25. When the two pieces of heartbeat information are not the same, the electronic device 2410 (for example, the processor 480) may perform operation 2615. Since it is not identified whether the user of the electronic device 2410 and the user of the accessory device 2420 are the same, the electronic device 2410 (for example, the processor 480) may identify that the pairing between the two devices has failed and end the process.

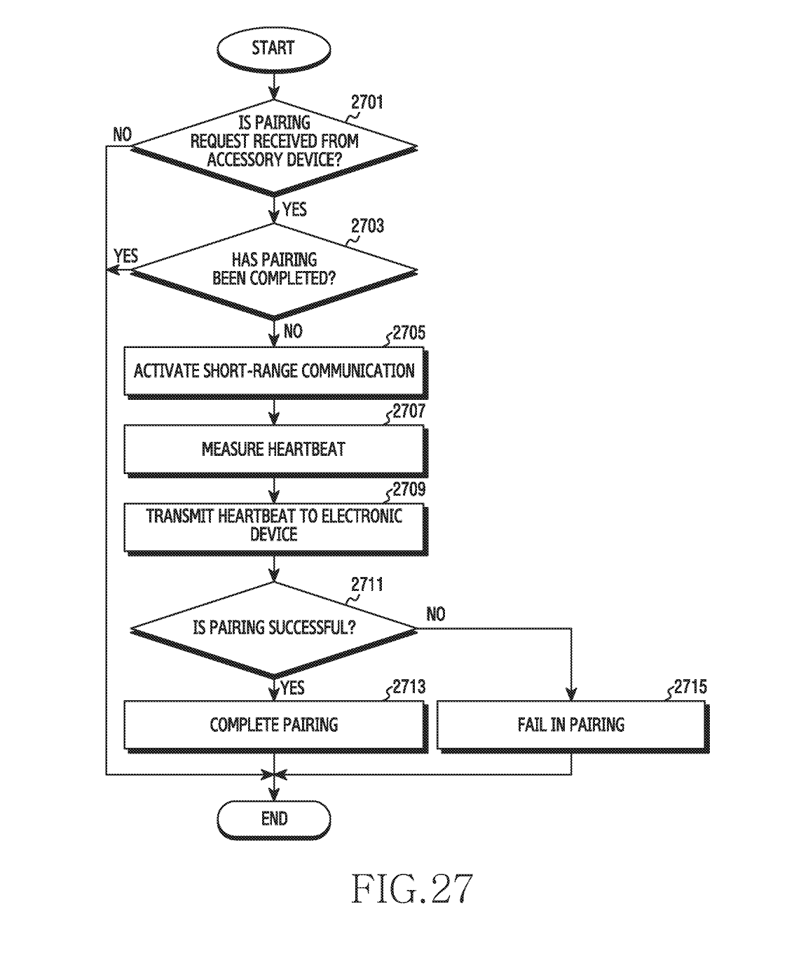

FIG. 27 is a flowchart illustrating an example operation in which the accessory device transmits heartbeat information to the electronic device to perform pairing according to another example embodiment of the present disclosure.

Referring to FIG. 27, when a pairing request signal with the electronic device 2410 (for example, the electronic device 400) is received from the user in operation 2701, the accessory device 2420 may perform operation 2703. When the pairing request signal is not received, the accessory device 2420 may wait for receiving the pairing request signal. The accessory device 2420 may identify whether the pairing with the electronic device 2410 has been completed in operation 2703. When the pairing with the electronic device 2410 has been completed based on a result of the identification of operation 2703, the accessory device 2420 may end the process.

When the pairing with the electronic device 2410 has not been completed based on a result of the identification of operation 2703, the accessory device 2420 may perform operation 2705. The accessory device 2420 may activate short-range communication to transmit heartbeat information to the electronic device 2410 in operation 2705. The short-range communication may be BLE communication. The accessory device 2420 may be wirelessly connected to the electronic device 2410 through short-range communication.

The accessory device 2420 may measure user's heartbeat information through the biometric information included in the accessory device 2420 in operation 2707. The accessory device 2420 may transmit the measured heartbeat information to the electronic device 2410 through the short-range communication in operation 2709. The accessory device 2420 may identify whether the pairing with the electronic device 2410 is successful in operation 2711. When the pairing with the electronic device 2410 is successful in operation 2711, the accessory device 2420 may perform operation 2713. The accessory device 2420 may complete the pairing with the electronic device 2410 in operation 2713 and store information on the paring with the electronic device 2410. When the paring with the electronic device 2410 is not successful in operation 2711, the accessory device 2420 may perform operation 2715. Since the accessory device 2420 has failed the pairing with the electronic device 2410 in operation 2715, the process may end.

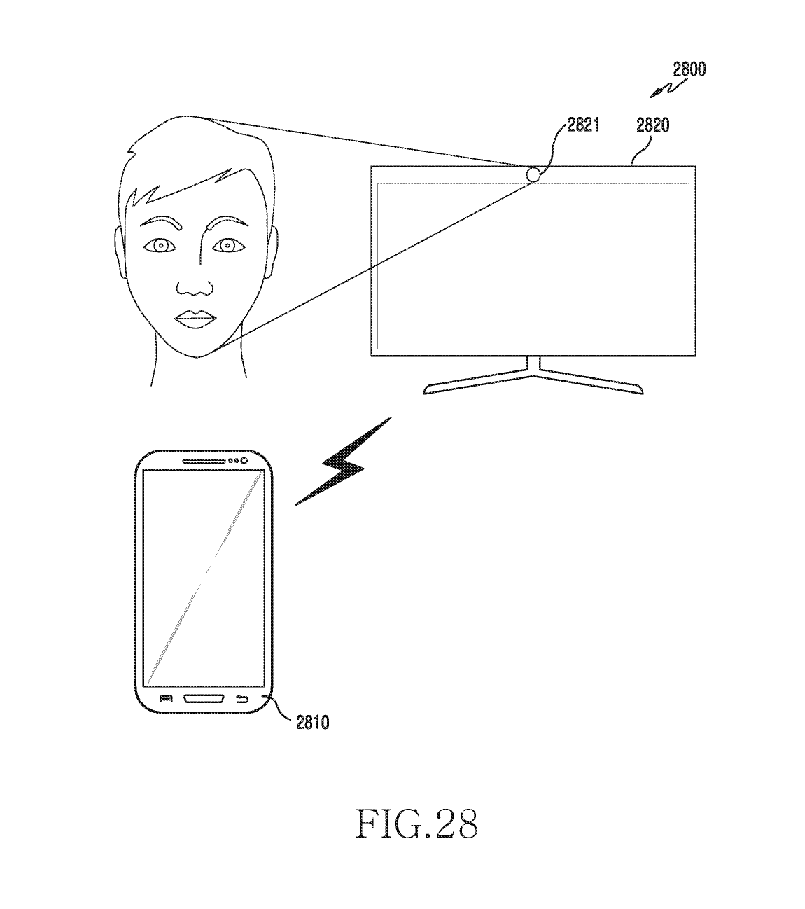

FIG. 28 is a diagram illustrating an example system including an example electronic device and an external electronic device according to another example embodiment of the present disclosure.

Referring to FIG. 28, a system 2800 according to an example embodiment of the present disclosure may include an electronic device 2810 and an external device 2820.

The electronic device 2810 may include the same elements as those of the electronic device 400 illustrated in FIG. 4. Accordingly, a detailed description of the elements of the electronic device 2810 is replaced with the elements of the electronic device 400. When a pairing request signal with the external device 2820 is input by the user, the electronic device 2810 (for example, the processor 480) may be paired with the external device 2820. The electronic device 2810 (for example, the processor 480) may acquire user's heartbeat information through one of the biometric sensors 423. The electronic device 2810 (for example, the processor 480) may receive the heartbeat information from the external device 2820 through short-range wireless communication such as BLE or wired communication with the external device 2820.

The electronic device 2810 (for example, the processor 480) may compare the heartbeat information acquired by the electronic device 2810 and the heartbeat information received by the external device 2820 and, when the two pieces of heartbeat information are the same, complete the pairing with the external device 2820. The electronic device 2810 (for example, the processor 480) may store an identification number of the external device 2820 with which the electronic device 2810 (for example, the processor 480) has completed the pairing, and pairing information, for example, heartbeat information. When the pairing with the external device 2820 is completed, the electronic device 2810 (for example, the processor 480) may activate the motion sensor 421. The electronic device 2810 (for example, the processor 480) may control the operation of the electronic device 2810 based on a motion of the electronic device 2810 received through the motion sensor 421. Since it has been described in detail with reference to FIGS. 5 to 22, a detailed description thereof will be omitted. Further, the electronic device 2810 (for example, the processor 480) may transmit a motion of the electronic device 2810 received through the motion sensor 421 to the external device 2820 and control the operation of the external device 2820 based on the motion.

When a pairing request signal with the electronic device 2810 is input by the user, the external device 2820 may acquire user's heartbeat information through a camera 2821 included in the external device 2820. The external device 2820 may acquire image data for a user's face for a predetermined time through the camera 2821. The external device 2820 may analyze the user's face within the acquired image data and identify a change in a color of the analyzed face. The external device 2820 may acquire heartbeat information based on the color change. The external device 2820 may transmit the acquired heartbeat information to the electronic device 2810 through short-range communication such as BLE or wired communication. When the pairing with the electronic device 2810 is completed, the external device 2820 may deactivate the short-range wireless communication or the wired communication. The external device 2820 may transmit heartbeat information to the electronic device 2810 with which the external device 2820 has completed the pairing in real time or periodically. When motion information is received from the electronic device 2810 with which the external device 2820 has completed the pairing, the external device 2820 may control the operation of the external device 2820 based on the received motion.

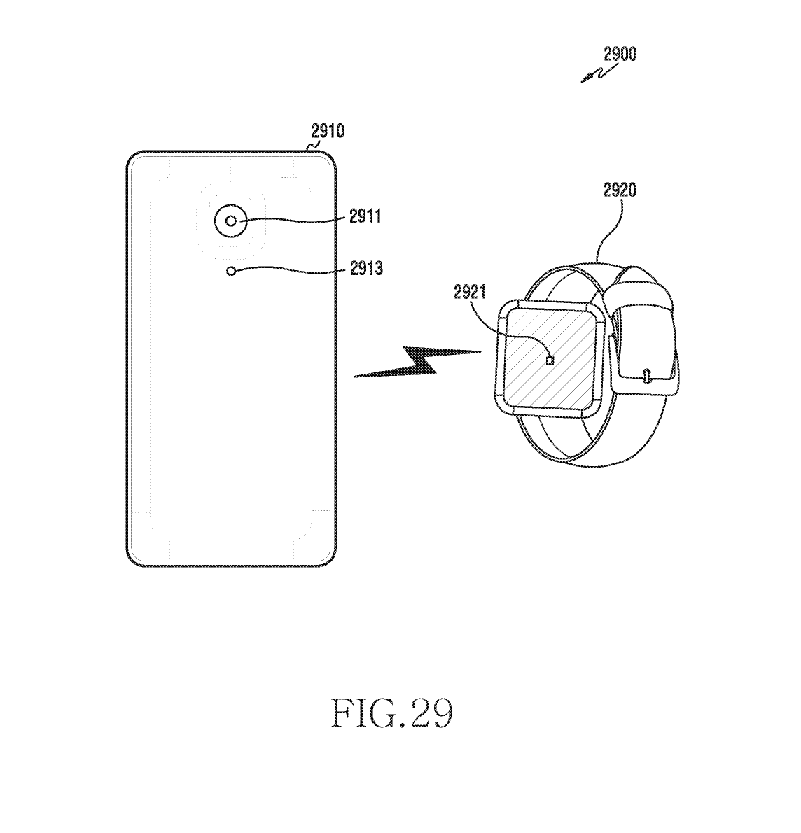

FIG. 29 is a diagram illustrating example locations of sensors included in the electronic device and the accessory device according to another example embodiment of the present disclosure.

According to an example embodiment, referring to FIG. 29, a system 2900 according to an embodiment of the present disclosure may include an electronic device 2910 and an accessory device 2920. The electronic device 2910 may include the same elements as those of the electronic device 400 illustrated in FIG. 4 and the electronic device 2410 illustrated in FIG. 24. Accordingly, a detailed description of the elements of the electronic device 2910 is replaced with the elements of the electronic device 400. The electronic device 2910 may include a camera 2911 on the rear surface of the electronic device 2910. The electronic device 2910 may include a sensor 2913, for example, the proximity sensor 422 or the biometric sensor 423, which may identify the proximity of the user, below the camera 2911.

When a pairing request signal with the accessory device 2920 (for example, the accessory device 2420) is input by the user, the electronic device 2910 (for example, the processor 480) may be paired with the accessory device 2920. The electronic device 2910 (for example, the processor 480) may identify user's heartbeat information through the sensor 2913 located on the rear surface of the electronic device 2910. The electronic device 2910 (for example, the processor 480) may receive heartbeat information from the accessory device 2920 through short-range wireless communication such as BLE with the accessory device 2920.

The accessory device 2920 may include a sensor 2921, for example, the biometric sensor on the rear surface of the frame of the accessory device 2920. The accessory device 2920 may acquire the user's heartbeat information through the sensor 2921. The accessory device 2920 may transmit the acquired heartbeat information to the electronic device 2910 through short-range wireless communication such as BLE. The electronic device 2910 (for example, the processor 480) may perform pairing based on the heartbeat information measured by the sensor 2913 included in the electronic device 2910 and the heartbeat information measured by the sensor 2921 included in the accessory device 2920.

As described above, the electronic device and the method of operating the same according to the present disclosure may change and provide a screen displayed on the touch screen based on a motion of the electronic device to make the electronic device controlled easily according to the motion. Accordingly, it is possible to provide convenience to allow the user to control the electronic device with one hand regardless of the size of the electronic device.

Meanwhile, various example embodiments of the present disclosure illustrated and described in this description and the drawings correspond to various examples presented in order to easily explain technical contents of the present disclosure, and to aid in comprehension of the present disclosure, but are not intended to limit the scope of the present disclosure. That is, it is will be apparent to those skilled in the art to which the present disclosure belongs that different modifications can be achieved based on the technical spirit of the present disclosure.

1-20. (canceled)

21. An electronic device comprising:
a first sensor;
a second sensor; and
a processor configured to:
identify a proximity of a user of the electronic device through the first sensor,
in response to identifying the proximity of the user of the electronic device, acquire motion information through the second sensor, while the proximity of the user of the electronic device is maintained, and
execute at least one function based on the acquired motion information while the proximity of the user of the electronic device is maintained.

22. The electronic device of claim 21, wherein the processor is configured to change at least a part of a user interface based on one or more of a speed, a direction, a size, or a change amount of the motion information.

23. The electronic device of claim 21, wherein the processor is configured to move at least one content displayed on the electronic device in a direction corresponding to a direction of the motion information.

24. The electronic device of claim 21, wherein the processor is configured to execute a first function corresponding to the motion information when the motion information corresponds to a first motion, and to execute a second function corresponding to the motion information when the motion information corresponds to a second motion.

25. The electronic device of claim 21, wherein, when the proximity of the user is not detected through the first sensor, the processor is configured to inactivate the second sensor.

26. The electronic device of claim 21, wherein the motion information includes at least one of a motion of eyes of the user or a motion of the electronic device.

27. The electronic device of claim 21, wherein each of the first sensor and the second sensor comprises at least one of a proximity sensor, a biometric sensor, a gyrometric sensor, a motion sensor or a camera.

28. The electronic device of claim 27, wherein the processor is further configured to identify a function corresponding to the motion of the electronic device acquired through the motion sensor and to perform the identified function.

29. The electronic device of claim 27, wherein the at least one function comprises scrolling the screen data, moving some areas of the screen data, enlarging and reducing the screen, or changing a menu in the application based on the motion of the eyes of the user.

30. The electronic device of claim 27, wherein, when the motion of the electronic device is not acquired by the motion sensor, the processor is further configured to maintain a brightness of the display unit after a threshold time passes.

31. The electronic device of claim 27, wherein the biometric sensor includes at least one of a heartbeat sensor, a temperature sensor, or a vein sensor, and the processor is configured to be paired with an external electronic device based at least one piece of heartbeat information, temperature information, and vein information detected by the biometric sensor.

32. A method of operating an electronic device, the method comprising:
identifying proximity of a user through a first sensor of the electronic device;
in response to identifying the proximity of the user of the electronic device acquiring motion information through a second sensor of the electronic device while the proximity of the user of the electronic device is maintained; and
executing at least one function based on the acquired motion information while the proximity of the user of the electronic device is maintained.

33. The method of claim 32, further comprising:
identifying whether the application is an application interworking with the second sensor; and
activating the second sensor.

34. The method of claim 32, wherein the motion information includes at least one of a motion of eyes of the user or a motion of the electronic device.

35. The method of claim 32, wherein each of the first sensor and the second sensor comprises at least one of a proximity sensor, a biometric sensor, a gyrometric sensor, a motion sensor or a camera.

36. The method of claim 35, further comprising:
identifying first sensing information when the second sensor is activated;
identifying second sensing information corresponding to the motion of the eyes of the user or the motion of the electronic device when the motion is detected; and
determining a change value between the first sensing information and the second sensing information.

37. The method of claim 36, further comprising:
determining a function corresponding to the determined change value; and
executing the function when the function exists.

38. The method of claim 37, further comprising executing, based on the change value, at least one of scrolling the screen data, moving some areas of the screen data, enlarging and reducing the screen, or changing a menu in an application of the electronic device.

39. The method of claim 32, further comprising moving at least one content displayed on the electronic device in a direction corresponding to a direction of the motion information.

40. The method of claim 32, further comprising:
executing a first function corresponding to the motion information when the motion information corresponds to a first motion; and
executing a second function corresponding to the motion information when the motion information corresponds to a second motion.
